(19) United States
(12) Patent Application Publication
(10) Pub. No.: US 2024/0000108 A1
(43) Pub. Date: Jan. 4, 2024

(54) INSECT OIL IN SWINE FEED

(71) Applicant: CAN TECHNOLOGIES, INC., Wayzata, MN (US)

(72) Inventors: Gilles Caby, Pont Pean (FR); Guilherme Hosotani, St. Polten (AT); Delphine Marie Pierre Melchior, Cervin (FR); Rosalie Van Beek-Van Emous, Putten (NL)

(21) Appl. No.: 18/252,386

(22) PCT Filed: Nov. 11, 2021
(86) PCT No.: PCT/US2021/072345

§ 371 Date: May 10, 2023

Related U.S. Application Data
(60) Provisional application No. 63/217,374, filed on Jul. 1, 2021.
(60) Provisional application No. 63/113,603, filed on Nov. 13, 2020.

(51) Int. Cl. A23K 20/158; A23K 50/60; A23K 50/30

(52) U.S. Cl. CPC A23K 20/158; A23K 50/60; A23K 50/30

(57) ABSTRACT

The present disclosure generally relates to a swine feed or swine feed product including insect oil, for example about 0.1 wt % to about 10.0 wt %. In general, the insect oil comprises lauric acid, for example, at least 35% lauric acid. Also provided are methods for feeding a pig, in particular a sow or piglet, said swine feed.

### CROSS REFERENCE TO RELATED APPLICATIONS

This application claims the benefit of U.S. Provisional Application No. 63/113,603, filed Nov. 13, 2020, and U.S. Provisional Application No. 63/217,374, filed Jul. 1, 2021, each of which is incorporated by reference herein in its entirety.

### FIELD OF THE INVENTION

The invention generally relates to swine feed and methods for feeding the swine feed to pigs, e.g., sows, piglets, and grower finisher phase pigs.

### BACKGROUND OF THE INVENTION

Increasing piglet litter sizes is a trend in the global swine farming industry. However, these larger litter sizes are associated with lower piglet birth weights and higher pre-weaning mortality. The weaning process itself is stressful for both the sow and the piglet resulting in reduced feed intake, impaired gut health, impaired growth performance, and incidence of diarrhea, also known in the art as scours. A variety of factors may play a contributing roll in these indicators including sow feed compositions and piglet creep feed compositions.

Additionally, animal farming, feed production, and feed raw materials are major contributors to climate change potential, energy use, and land use. Alternative raw materials for animal feeds and modified animal farming practices have the potential to greatly reduce the stress on climate change and energy/land use caused by these practices.

Therefore, a need in the art exists for additional swine feed compositions and rearing methods to increase piglet weaning weight, decrease pre-weaning mortality, and overall improve growth performance of piglets, while balancing the need for alternative feed raw materials and modified animal farming practices.

### SUMMARY OF THE INVENTION

A first aspect of the present invention relates to a composition that is a swine feed or a feed product for forming the swine feed, the composition comprising insect oil, wherein the insect oil is 0.1 wt % to 10.0 wt % of the swine feed. The insect oil may be 0.5 wt % to 4.0 wt % of the swine feed. The swine feed may comprise about 15 wt % to about 25 wt % protein, about 1 wt % to about 8 wt % fat, and about 25 wt % to about 50 wt % starch. The swine feed may comprise insect oil and at least one of corn oil, animal fat, vegetable oil, animal-vegetable oil blend, coconut oil, soybean oil, sunflower oil, shea oil, palm oil and combinations thereof. The composition may be a complete swine feed.

The insect oil may comprise about 35% to about 60% lauric acid. The insect oil may comprise about 40 wt % to about 55% lauric acid. The insect oil may be extracted from Hermetia illucens larvae.

The swine feed may comprise about 0.01% to about 2.75% lauric acid. The swine feed may additionally comprise vitamins, trace minerals, essential amino acids, edible plant materials, grain, barley, corn, soy, rice, wheat, whey, essential oils, organic acids, or a combination thereof.

The swine feed may be formulated for use in at least one of a breeding, gestation, farrowing, or lactation phase of a sow. The swine feed may be formulated as a feed for a piglet less than or equal to 60 days old. The swine feed may be formulated as feed for a piglet less than or equal to 21 days old. The swine feed may be formulated as a feed for a piglet between about 21 and about 35 days old. The swine feed may be formulated as a feed for a piglet between about 35 and about 60 days old.

The feed product may comprise a milk substitute, a premix, a concentrate, a base mix, a supplement, a top dress, or a combination thereof. The feed product may be formulated to form the swine feed by combining with a base swine feed such that the feed product is 30 wt % or less of the swine feed. The feed product may be formulated to form the swine feed by combining with a base swine feed such that the feed product is 1 wt % to 5 wt % of the swine feed.

A second aspect of the present invention relates to a method for feeding a pig comprising feeding the pig a swine feed as described herein. The pig may be a sow in a gestation, farrowing, or lactation phase during the feeding. In some embodiments, the method decreases pre-weaning mortality of an offspring of the sow, increases livability of an offspring of the sow, decreases number of stillborn offspring of the sow, increases average daily weight gain of an offspring of the sow, increases average weight at weaning of an offspring of the sow, or a combination thereof as compared to a corresponding method using a swine feed that does not include insect oil. The pig may be a piglet less than or equal to 60 days old. In some embodiments, the method increases body weight or feeding efficiency of the piglet compared to a corresponding method using a swine feed that does not include insect oil.

In some embodiments of the second aspect, the swine feed is a daily feed ration that is fed to the pig on most days or on all days.

A third aspect of the present invention relates to a method for increasing the weaning weight of piglets, the method comprising feeding a piglet milk from a sow fed a feed comprising about 0.1 wt % to about 10.0 wt % insect oil, whereby the piglets have a higher average weaning weight than piglets fed milk from a sow fed a feed without insect oil. The method may additionally comprise the step of feeding the sow the feed comprising about 0.1 wt % to about 10.0 wt % insect oil. The feed may comprise between about 0.5 wt % to about 4.0 wt % insect oil. The swine feed may comprise about 15 wt % to about 25 wt % protein, about 1 wt % to about 8 wt % fat, and about wt % to about 50 wt % starch. The swine feed may comprise insect oil and at least one of corn oil, animal fat, vegetable oil, animal-vegetable oil blend, coconut oil, soybean oil, sunflower oil, shea oil, palm oil and combinations thereof. The insect oil may comprise about 35% to about 60% lauric acid or about 40 wt % to about 55% lauric acid. The insect oil may be extracted from Hermetia illucens larvae. The swine feed may comprise about 0.01% to about 2.75% lauric acid. The swine feed may additionally comprise vitamins, trace minerals, essential amino acids, whey, edible plant materials, grain, barley, corn, soy, rice, wheat, organic acids, essential oils, or a combination thereof. The weaning weight of the piglets may be measured between day 17 and day post birth. The weaning weight of the piglets may be at least 4% higher than the weaning weight of piglets in a corresponding method using swine feed without the insect oil. The weaning weight of the piglets may be at least 12% higher than the weaning weight of piglets in a corresponding method using swine feed without the insect oil. In some embodiments, the piglets are additionally fed a feed comprising about 0.25% to about 5% insect oil.

In a fourth aspect the present invention relates to a method for increasing feed efficiency in a piglet comprising feeding the piglet a swine feed comprising between about 0.1 wt % and about 10.0 wt % insect oil, whereby the feeding efficiency of the piglet is increase relative to the feeding efficiency of a piglet fed a feed without insect oil. The piglet may be between 0 and 60 days old. The piglet may be less than 21 days old. The piglet may be between 21 and 35 days old and fed a swine feed comprising between about 1.0 wt % and about 5 wt % insect oil. The piglet may be between 35 and 60 days old and fed a swine feed comprising between about 0.1 wt % and about 3 wt % insect oil. The swine feed may comprise about 15 wt % to about 25 wt % protein, about 1 wt % to about 8 wt % fat, and about 25 wt % to about 50 wt % starch. The swine feed may comprise insect oil and at least one of corn oil, animal fat, vegetable oil, animal-vegetable oil blend, coconut oil, soybean oil, sunflower oil, shea oil, palm oil and combinations thereof. The insect oil may comprise about 35% to about 60% lauric acid or about 40 wt % to about 55% lauric acid. The insect oil may be extracted from Hermetia illucens larvae. The swine feed may comprise about 0.01% to about 2.75% lauric acid. The swine feed may additionally comprise vitamins, trace minerals, essential amino acids, edible plant materials, grain, barley, corn, soy, rice, wheat, whey, or a combination thereof. The feed efficiency of the piglets may be at least 2% higher than the feed efficiency of piglets in a corresponding method using swine feed without the insect oil. The feed efficiency of the piglets may be at least 10% higher than the feed efficiency of piglets in a corresponding method using swine feed without the insect oil.

### BRIEF DESCRIPTION OF THE DRAWINGS

The drawings illustrate generally, by way of example, but not by way of limitation, various embodiments of the present invention.

FIG. 1 show swine lactation and nursery production phases.

FIGS. 2A and 2B show Phase I and Phase II trial diets, respectively, for the trial described in Example 1.

FIG. 3 shows body weight of piglets in the trial outlined in Example 1.

FIG. 4 shows average daily gain (ADG), average daily feed intake (ADFI), and feed efficiency gain:feed (G:F) across days 0-8 of Example 1.

FIG. 5 shows ADG, ADFI, and G:F across days 8-14 of Example 1.

FIG. 6 shows ADG, ADFI, and G:F across days 14-26 of Example 1.

FIG. 7 shows ADG, ADFI, and G:F across days 26-39 of Example 1.

FIG. 8 shows ADG, ADFI, and G:F across days 0-39 of Example 1.

FIG. 9 shows fecal score for piglets in Example 1.

FIG. 10 shows sodium and triglyceride levels at day 8 in the piglets of Example 1.

FIG. 11 shows alkaline phosphate and triglyceride at day 26 in piglets of Example 1.

FIG. 12 shows cholesterol levels at day 8 in the piglets of Example 1.

FIG. 13 shows triglyceride levels at day 26 in the piglets of Example 1.

FIG. 14 shows body weight of piglets in the lactation phase of Example 2.

FIG. 15 shows ADG growth performance of piglets in the lactation phase of Example 2.

FIG. 16 shows total feed intake (FI) performance of piglets in the lactation phase of Example 2.

FIG. 17 shows body weight of piglets in the nursery phase of Example 2.

FIG. 18 shows ADG growth performance of piglets in the nursery phase of Example 2.

FIG. 19 shows ADFI growth performance of piglets in the nursery phase of Example 2.

FIG. 20 shows G:F growth performance (feed efficiency) of piglets in the nursery phase of Example 2.

FIG. 21 shows the effect of insect oil on piglet feed intake in Example 5.

FIG. 22 shows the effect of insect oil on piglet feed intake in Example 6.

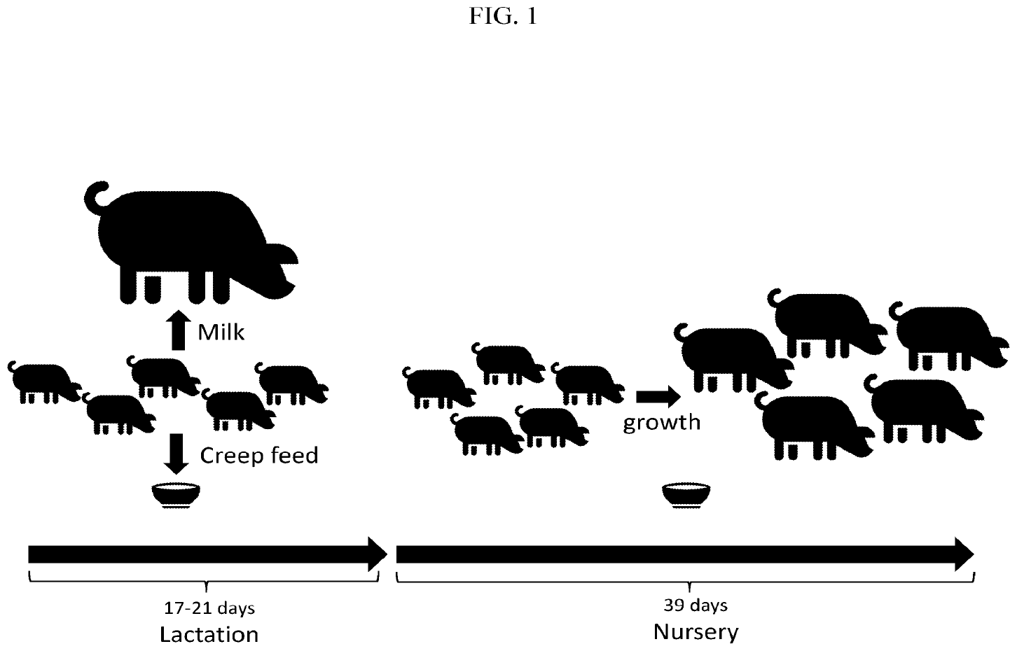

### DETAILED DESCRIPTION OF THE INVENTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that less than 5.0 wt %, less than 2.0 wt %, less than 1.5 wt %, less than 1.0 wt %, less than 0.5 wt %, less than 0.1 wt %, less than 0.01 wt %, less than 0.001 wt %, or about 0 wt % of the material is present in the composition.

### Swine Feed Compositions Including Insect Oil

Various aspects of the present disclosure provide a composition including insect oil. The composition is a swine feed, or a feed product for forming the swine feed. The feed product can be designed to be mixed with another composition, such as a base swine feed, to form the swine feed.

The swine feed can be formulated for use in any suitable life stage of the swine, such as for use with sows (e.g., gestating, farrowing, or lactating sows), piglets (e.g., a lactation phase piglet or a post-weaning nursery phase piglet), and/or grower finisher phase pigs (e.g., from about 60 days of age until slaughter).

As used herein, “insect oil” refers to a lipid composition extracted from an insect. The insect oil may be in the form or a liquid or a solid and may also be known in the art as “insect fat.” The insect oil may be in the form of a liquid oil extracted from insect larvae and separated from a protein faction, for example, using a screw press, oil press, carbon dioxide supercritical extraction, ultrasound assisted Soxhlet extraction, and the like. Methods for oil/lipid extraction from insects are known and described in the art. See, for example, Matthaus et al. (“Renewable Resources from Insects: Exploitation, Properties, and Refining of Fat Obtained by Cold-Pressing from Hermetia illucens (Black Soldier Fly) Larvae,” European Journal of Lipid Science and Technology, 2019), Kim et al. (“Removal of fat from crushed black soldier fly larvae by carbon dioxide supercritical extraction,” Journal of Animal and Feed Sciences, 2019; 28(1)83-88), Smets et al. (“Sequential Extraction and Characterisation of Lipids, Proteins, and Chitin from Black Soldier Fly (Hermetia illucens) Larvae, Prepupae, and Pupae,” Waste and Biomass Valorization, 2020), Mai et al. (“Purification Process, Physicochemical Properties, and Fatty Acid Composition of Black Soldier Fly (Hermetia illucens Linnaeus) Larvae Oil,” JAOCS, 2019: 96(11): 1303-1311), WO2014123420 (“Method to convert insects or worms into nutrient streams and compositions obtained thereby”), and CN106701313 (“Method for extracting Hermetia illucens larva oil through ultrasound-assisted soxhlet extraction method”). The insect oil may be used in addition to or may completely replace traditional lipid sources in swine feeds such as, but not limited to, soybean oil and/or palm oil. The insect oil may be extracted from Hermetia illucens larvae, Tenebrio molitor larvae, and the like.

In general, insect oil has a high lauric acid and high medium chain fatty acid (MCFA) content that distinguishes it from vegetable or plant-based oils currently used in swine feeds. The insect oil may include between about 35% and about 60% lauric acid, between about 40% and about 55% lauric acid, or about 45% to about 55% lauric acid. The insect oil may include at least 35%, at least 40%, at least 45%, at least 48%, at least 50%, or at least 55% lauric acid. The insect oil may include about 40%, about 42%, about 44%, about 45%, about 48%, about 49%, about 50%, about 52%, about 55%, about 58%, or about 60% lauric acid. The insect oil may include between about 35% and about 60% MCFA, between about 40% and about 55% MCFA, or about 45% to about 55% MCFA. The insect oil may include at least 35%, at least 40%, at least 45%, at least 48%, at least 50%, at least 55%, or at least 60% MCFA. The insect oil may include about 40%, about 42%, about 44%, about 45%, about 48%, about 49%, about 50%, about 52%, about 55%, about 58%, or about 60% MCFA.

The insect oil can form any suitable portion of the swine feed. For example, the insect oil can be about 0.1 wt % to about 10.0 wt % of the swine feed, about 0.2 wt % to about 8 wt %, about 0.3 wt % to about 5 wt %, or about 0.5 wt % to about 4 wt %. The insect oil can be about 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.2 wt %, 2.4 wt %, 2.6 wt %, 2.8 wt %, 3.0 wt %, 3.2 wt %, 3.4 wt %, 3.6 wt %, 3.8 wt %, 4.0 wt %, 4.2 wt %, 4.4 wt %, 4.6 wt %, 4.8 wt %, 5 wt %, 5.5 wt %, 6 wt %, 6.5 wt %, 7.0 wt %, 7.5 wt %, 8.0 wt %, 8.5 wt %, 9.0 wt %, 9.5% wt %, or 10.0 wt % of the swine feed.

The swine feed can be a complete swine feed. A complete swine feed is a nutritionally adequate feed for swine that is compounded to be fed as the sole ration and can maintain life and/or promoting growth and production without any additional substances being consumed except water. Complete feeds are compounded mixtures containing all the nutrients of concentrates plus various energy sources such as grains (starch), some fat, and the like. In addition, certain major vitamins and minerals may be added. A complete feed can include ingredients such as, but not limited to, cottonseed meal, rapeseed meal, canola meal, meat and bone meal, wheat middlings, soybean meal, whey, whey permeate, dairy byproducts, barley, corn, wheat, rice, edible plant materials, corn gluten meal, distillers grains, blood meal, salt, fat sources, corn oil, animal fat, vegetable oil, animal-vegetable oil blend, coconut oil, soybean oil, sunflower oil, shea oil, palm oil, macro-minerals, minerals, vitamins, essential amino acids, enzymes, essential oils, organic acids and combinations thereof.

The total protein in the swine feed may be between about 10 wt % and about 30 wt %, between about 15 wt % and about 25 wt %, between about 16 wt % and about 21 wt %, or between about 17 wt % and about 20 wt %. The total protein in the swine feed may be variable depending on the formulation and intended use of the feed. For example, a swine feed formulated for a breeding, gestating, farrowing, or lactating sow may include about 11 wt % to about 19 wt % protein. A swine feed formulated for gestating sow may include about 12 wt % to about 16 wt % protein. A swine feed formulated for a lactating sow may include about 12.5% wt % to about 18.5 wt % protein. A swine feed formulated for a lactation phase piglet (e.g., piglets age 0 days to about 21 days) may include about 17 wt % to about 19 wt % protein. A swine feed formulated for a piglet age about 21 days to about 35 days may include about 16 wt % to about 21 wt % protein or about 18.5 wt % to about 20.5 wt %. A swine feed formulated for a piglet age about 35 days to about 60 days may include about 15.5 wt % to about 19 wt % protein or about 16 wt % to about 18.5 wt %. A swine feed formulated for the grower finisher stage pig at age about 60 days to slaughter may include about 12.5 wt % to about 20.5 wt % protein, about 15.5 wt % to about 19 wt % protein, or about 16 wt % to about 18.5 wt % protein. A skilled artisan will recognize the various protein requirements of swine receiving the swine feed and can adjust the total protein as necessary.

Total fat (e.g., oil, fat, and/or lipids) in the swing feed may be between about 0.1 wt % and about 10 wt %, between about 1 wt % and about 8 wt %, between about 2 wt % and about 6 wt %, or between about 3 wt % and about 5.5 wt %. The total fat in the swine feed may be variable depending on the formulation and intended use of the feed. For example, a swine feed formulated for a breeding, gestating, farrowing, or lactating sow may include about 1 wt % to about 8 wt % fat, about 2 wt % to about 6 wt % fat, or about 5 wt % fat. A swine feed formulated for a lactation phase piglet (e.g., piglets age 0 days to about 21 days) may include about 2 wt % to about 8 wt % fat, about 3 wt % to about 7 wt % far, or about 6 wt % fat. A swine feed formulated for a piglet age about 21 days to about 35 days may include about 1 wt % to about 5 wt % fat, about 2 wt % to about 4 wt % far, or about 3 wt % fat. A swine feed formulated for a piglet age about 35 days to about 60 days may include about 0.1 wt % to about 3 wt % fat, about 0.5 wt % to about 2 wt % fat, or about 1 wt % fat. A swine feed formulated for the grower finisher age about 60 days to slaughter may include about 0.1 wt % to about 3 wt % fat, about 0.5 wt % to about 2 wt % fat, or about 1 wt % fat. A skilled artisan will recognize the various fat requirements of swine receiving the swine feed and can adjust the total fat as necessary.

The total fat in the swine feed may be insect oil, or it may be a combination of insect oil and one or more other lipid sources including, but not limited to, corn oil, animal fat, vegetable oil, animal-vegetable oil blend, coconut oil, soybean oil, sunflower oil, shea oil, palm oil and combinations thereof. Different lipid sources may be characterized by different fatty acid profiles and combinations of the various oils with various fatty oil profiles may be desired. Table 1 lists exemplary fatty acid profiles for soybean oil, coconut oil, and one example of insect oil extracted from Hermetia illucens larvae.

TABLE 1
Exemplary Fatty Acid Profiles

| | Soybean | Coconut | Insect oil |
|---|---|---|---|
| Nutrient | oil (%) | oil (%) | (analyzed) * (%) |
| Crude fat | 99.5 | 99.5 | 99.7 |
| Polyunsaturated Fat (PUFA) | 59.1 | 1.89 | 12 |
| Monounsaturated Fat | 21.0 | 6.62 | 13 |
| (MFA) | | | |
| Saturated Fat (SFA) | 14.4 | 86 | 75 |

Saturated FA (%)

| | | | |
|---|---|---|---|
| C12:0 - Lauric | — | 44.4 | 49 |
| C14:0 - Myristic | 0.19 | 16.7 | 9.6 |
| C16:0 - Palmitic | 10.4 | 8.16 | 13 |
| C18:0 - Stearic | 4.08 | 2.79 | 1.8 |

Monounsaturated FA (%)

| | | | |
|---|---|---|---|
| C16:1 - Palmitoleic | 0.19 | — | 2.3 |
| C18:1 - Oleic | 22.2 | 5.77 | 10 |

Polyunsaturated FA (%)

| | | | |
|---|---|---|---|
| C18:2 - Linoleic | 51.1 | 1.71 | 11 |
| C18:3 - Linolenic | 7.58 | — | 1.3 |

* Hermetia illucens larvae extract

Total starch in the swine feed may be between about 20 wt % and about 55 wt %, between about 25 wt % and about 50 wt %, between about 30 wt % and about 48 wt %, or between about 32 wt % and about 45 wt %. The total starch in the swine feed may be variable depending on the formulation and intended use of the feed. For example, a swine feed formulated for a breeding, gestating, farrowing, or lactating sow may include about 33.5 wt % to about 38 wt % starch. A swine feed formulated for a lactation phase piglet (e.g., piglets age 0 days to about 21 days) may include about 29 wt % to about 34 wt % starch. A swine feed formulated for a piglet age about 21 days to about 35 days may include about 30 wt % to about 35 wt % starch. A swine feed formulated for a piglet age about 35 days to about 60 days may include about 35 wt % to about 45 wt % starch or about 40 wt % to about 45 wt % starch. A swine feed formulated for the grower finisher age about 60 days to slaughter may include about 40 wt % to about 50 wt % starch or about 42 wt % to about 47 wt % starch. A skilled artisan will recognize the various starch requirements of swine receiving the swine feed and can adjust the total starch as necessary.

Lauric acid can form any suitable proportion of the swine feed. For example, the swine feed may include about 0.01 wt % to about 3.5 wt % lauric acid, about 0.05 wt % to about 3.0 wt %, about 0.085 wt % to about 2.75 wt %, or about 0.1 wt % to about 2.5 wt % lauric acid. The swine feed may include about 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.4 wt %, 0.6 wt %, 0.8 wt %, 1.0 wt %, 1.2 wt %, 1.4 wt %, 1.6 wt %, 1.8 wt %, 2.0 wt %, 2.2 wt %, 2.4 wt %, 2.6 wt %, 2.8 wt %, 3.0 wt %, 3.2 wt %, or about 3.5 wt % lauric acid.

As used herein, “medium chain fatty acid” or “MCFA” are used interchangeably and refer to saturated or unsaturated fatty acids with 6-12 carbon atoms (e.g., C6-C12 fatty acids). Medium chain fatty acids may include, but are not limited to, caproic acid (C6), caprylic acid (C8), capric acid (C10), and lauric acid (C10). The MCFA may be saturated or unsaturated fatty acids.

MCFA can form any suitable proportion of the swine feed. For example, the swine feed may include about 0.01 wt % to about 3.5 wt % MCFA, about 0.05 wt % to about 3.0 wt %, about 0.085 wt % to about 2.75 wt %, or about 0.1 wt % to about 2.5 wt % MCFA. The swine feed may include about 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.4 wt %, 0.6 wt %, 0.8 wt %, 1.0 wt %, 1.2 wt %, 1.4 wt %, 1.6 wt %, 1.8 wt %, 2.0 wt %, 2.2 wt %, 2.4 wt %, 2.6 wt %, 2.8 wt %, 3.0 wt %, 3.2 wt %, or about 3.5 wt % MCFA.

Saturated fatty acids may form any suitable proportion of the swine feed. For example, the swine feed may include about 0.01 wt % to about 7.5 wt % saturated fatty acids, about 0.05 wt % to about 6 wt %, about 0.085 wt % to about 5 wt %, or about 0.1 wt % to about 3 wt % saturated fatty acids. The swine feed may include about 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.4 wt %, 0.6 wt %, 0.8 wt %, 1.0 wt %, 1.2 wt %, 1.4 wt %, 1.6 wt %, 1.8 wt %, 2.0 wt %, 2.2 wt %, 2.4 wt %, 2.6 wt %, 2.8 wt %, 3.0 wt %, 3.2 wt %, 3.5 wt %, 4.0 wt %, 4.5 wt %, 5.0 wt %, 5.5 wt %, 6.0 wt %, 6.5 wt %, 7.0 wt %, or 7.5 wt % saturated fatty acids.

The swine feed product can be any suitable feed product designed for mixing with another composition, such as a base feed, to form the swine feed. The swine feed product can include a premix, a concentrate, a base mix, a supplement, a top dress, or a combination thereof.

A base feed can be a commercially available feed or other animal feed. A base feed suitable for swine can refer to a ration that contains any of the various cereal grains, their by-products, and other sources of primary nutrition (e.g., fat, starch, and protein) such as barley, blood meal, bone meal, Brewer's grain, corn grain, corn gluten meal, corn gluten feed, cottonseed (e.g., whole or meal), distiller's grain, fish meal, hominy, feather meal, molasses, whey, whey permeate, dairy byproducts, soybeans (e.g., whole or meal), tallow, wheat (e.g., whole, bran or middlings), or a combination thereof.

A premix is a composition that can include vitamins, minerals, appropriate medications, carriers, and combinations thereof, and are typically less than 1% of the diet but can be higher. The carrier can increase bulk to improve distribution in compounding to prepare a more complete feed material. Examples of carriers can include soy mill run, rice bran, and similar edible plant by-products. Such premixes can be used to formulate concentrates and complete feeds.

A concentrate is a composition that can include high-protein feed components and can also include vitamins, minerals, appropriate medications, and combinations thereof. A concentrate is typically 5-40% of the diet but can be higher or lower. A concentrate can include additives. Concentrates can be used to make complete feeds by adding available grains or other energy sources. An additive is an ingredient or a chemical preparation or combination of ingredients which is added to the basic feed to fulfill a specific need. It is usually used in micro quantities and may have no nutritional value but is added to the feed to improve its quality and efficacy. Feed additives include, but not limited to, acidifiers, antioxidants, aromatics, deodorizing agents, flavor enhancers, mold inhibitors, pellet binders, preservatives, sweeteners, toxin binders, and the like.

A base mix can be similar to a supplement but contain only part of the animal's (e.g., the pig's) protein requirements, so is generally used with high protein ingredients and grain (e.g., ground grain and protein source, such as soybean meal) to form the swine feed. A base mix can include a mixture of one or more macro-mineral sources and one or more micro-ingredient sources such as vitamin premixes, trace mineral premixes, essential amino acids and feed additives, that when mixed with sources of protein and energy form a complete feed.

A supplement is a feed ingredient or a chemical preparation or combination of feed ingredients intended to supply the deficiencies in an animal (e.g., swine) feed and/or improve the nutritive balance or performance of the animal or swine feed. A top dress is a supplement added at specific time intervals to the swine's ration to provide a specific supplement or supplements over a period of time that makes it inconvenient or difficult to include in complete feed.

The swine feed product, such as a premix, a concentrate, a supplement, a top dress, or a base mix, can be formulated such that the swine feed product is any suitable proportion of the swine feed, such as 30 wt % or less of the swine feed, 10 wt % or less, 0.1 wt % to 30 wt %, 1 wt % to 30 wt %, 1 wt % to 15 wt %, 1 wt % to 5 wt %, 15 wt % to 30 wt %, or about 1 wt %, 2 wt %, 3 wt %, 4 wt %, 5 wt %, 6 wt %, 8 wt %, 10 wt %, 12 wt %, 14 wt %, 16 wt %, 18 wt %, 20 wt %, 22 wt %, 24 wt %, 26 wt %, 28 wt %, or 30 wt % the swine feed.

Insect oil can form any suitable proportion of the swine feed product, such as the premix, base mix, concentrate, supplement, top dress, or a combination thereof. The insect oil can be about 0.1 wt % to about 99.9 wt %, about 0.25 wt % to about 95 wt %, or about 0.5 wt % to about 90 wt % of the feed product, such that when the feed product is used to form a swine feed the final swine feed includes about 0.1% to about 10.0% insect oil.

The feed product including the insect oil can include any of the ingredients described herein, including but not limited vitamins, trace minerals, edible plant materials, grain, corn, soy, rice, wheat, or a combination thereof, as well as other feed ingredients known in the art. Lauric acid in the feed product can be in any suitable amount, such as about 0.01 wt % to about 99.9 wt %, such that the final swine feed includes about 0.01 to about 3.5 wt % lauric acid. MCFA in the feed product can be in any suitable amount, such as about 0.1 wt % to about 99.9 wt %, such that the final swine feed includes about 0.01 to about 3.5 wt % MCFA. Saturated fatty acids in the feed product can be in any suitable amount, such as about 0.1 wt % to about 99.9 wt %, such that the final swine feed includes about 0.01 to about 7.5 wt % saturated fatty acids.

### Method of Feeding a Pig

Various aspects of the present disclosure provide a method for feeding a pig. The method includes feeding the pig insect oil or a swine feed including the insect oil. The method provides certain advantages to the pig or its offspring as compared to a corresponding method using swine feed that does not include the insect oil. When the pig fed the insect oil is a sow, the method decreases pre-weaning mortality of an offspring of the sow, increases livability of an offspring of the sow, improves gut microbiota, improves gut morphology, reduces tail biting, reduces aggressive behavior, increases daily average weight gain of an offspring of the sow, increases average weight at weaning of an offspring of the sow, decreases the number of stillborn offspring of the sow, increases birth weight of an offspring of the sow, increases vitality of an offspring of the sow, increases the feed consumption of an offspring of the sow, increases the feed efficiency of an offspring of the sow, reduces the feed conversion of an offspring of the sow, or a combination thereof, as compared to a corresponding method using swine feed that does not include the insect oil. When the pig fed is a piglet between the ages of 0 days and 60 days, the method increases average weaning weight of the piglet, decreases pre-weaning mortality of the piglet, increases livability of the piglet, increases daily average weight gain of the piglet, increases feed efficiency of the piglet, or combinations thereof, as compared to a corresponding method using swine feed that does not include the insect oil. Advantages flowing from the methods described are not limited to any particular mode of operation.

The method can include any suitable method of feeding the insect oil to the pig. The feeding of the insect oil can include adding the insect oil to swine feed for ingestion by the pig. Feeding the pig the insect oil can include feeding the pig a swine feed as described herein. Feeding the pig the insect oil can include feeding the pig a swine feed that includes about 0.1 wt % to about 10.0 wt % insect oil (e.g., about 0.2 wt % to about 8 wt %, about 0.3 wt % to about 5 wt %, about 0.5 wt % to about 4 wt %, about 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.2 wt %, 2.4 wt %, 2.6 wt %, 2.8 wt %, 3.0 wt %, 3.2 wt %, 3.4 wt %, 3.6 wt %, 3.8 wt %, 4.0 wt %, 4.2 wt %, 4.4 wt %, 4.6 wt %, 4.8 wt %, 5 wt %, 5.5 wt %, 6 wt %, 6.5 wt %, 7.0 wt %, 7.5 wt %, 8.0 wt %, 8.5 wt %, 9.0 wt %, 9.5% wt %, or 10.0 wt % insect oil). The method can include combining a swine feed product described herein with a base feed to form the swine feed.

The method can include feeding a sow a swine feed including insect oil while the sow is in at least one of a breeding, gestation, farrowing, or lactation phase. The method can include feeding the swine feed to the sow through at least farrowing of the sow. The method can include feeding the swine feed to the sow during farrowing and continuing through weaning. The method can include feeding the swine feed to the sow after farrowing and before weaning. The swine feed can be a daily feed ration that is fed to the pig on most days or on all days.

The method can include feeding a piglet milk from a sow fed the swine feed with insect oil. For example, a lactating sow is fed the swine feed including the insect oil and from said sow is fed to piglet. The piglet may be fed the milk directly by the sow or the piglet may receive the milk in a bowl, cup or through other feeding methods. The piglet may be a piglet pre-weaning, for example, between about 0 days old and about 35 days old, between about 0 days old and about 25 days old, or between about 0 days old and about 21 days old. In addition to or instead of the sow's milk, the pre-weaning piglet may receive a creep fed including the insect oil or a milk replacement including insect oil. As used herein, “creep feed” refers to a swine feed fed to a pre-weaning piglet. The creep feed may be any swine feed described herein that includes the insect oil. As used herein, “milk replacement” refers to a powered or liquid formulation that substitutes or augments the nutrition a piglet would receive from sow's milk. For example, the milk replacement may include insect oil and whey powder, whey permeate, dairy byproducts, lactose, corn oil, animal fat, vegetable oil, animal-vegetable oil blend, coconut oil, soybean oil, sunflower oil, shea oil, palm oil, soy protein concentrate, potato protein, wheat gluten, spray-dried plasma protein, skim milk, additives, minerals, vitamins. Ingredients in milk replacer should mimic composition of milk from sows, therefore, high amount of milk components are included to provide lactose as energy source combined with fat sources. Highly digestible protein sources are required in milk replacer, which may also offer additional benefits on improving immune system by providing immunoglobulins (e.g. plasma protein).

The pig can by any pig, such as a domestic pig, Sus scrofa domesticus. The pig can be a pregnant sow. The pig can be a pre- or post-weaning piglet. The pig can be any suitable type of pig, such as a breed of domestic pig including Aksai Black Pied, American Yorkshire, Angeln Saddleback, Appalachian English, Arapawa Island, Auckland Island Pig, Australian Yorkshire, Ba Xuyen, Babi Kampung, Bangur Pig, Bantu, Basque, Bazna, Beijing Black, Belarus Black Pied, Belgian Landrace, Bengali Brown Shannaj, Bentheim Black Pied, Berkshire, Bisaro, Black Canarian Pig, Black Slavonian, Breitovo, British Landrace, British Lop, British Saddleback, Bulgarian White, Cantonese, Celtic Pig, Chato Murciano, Chester White, Chiangmai Blackpig, Moodum Chiangmai, Creole Pig, Cumberland Pig, Czech Improved White, Danish Landrace, Danish Protest Pig, Dermantsi Pied, Dharane Kalo Sungur, Duroc, Dutch Landrace Pig, East Balkan Pig, Essex, Estonian Bacon, Fengjing Pig, Finnish Landrance, Forest Mountain, French Landrace, Gascon, German Landrace, Gloucestershire Old Spot, Grice, Guinea Hog, Gottingen Minipig, Hampshire, Hante, Hereford, Hezuo, Hogan Hog, Huntingdon Black Hog, Iberian, Italian Landrace, Japanese Landrace, Jeju Black Pig, Jinhua Pig, Juliana, Kakhetian, Kele Pig, Kemerovo, Korean Native Pig, Krskopolje, Kunekune, Lacombe, Large Black, Large Black-White, Large White, Latvian White, Leicoma, Li Yan Pig, Lincolnshire Curly-Coated Pig, Linderodssvin, Lithuanian Native, Lithuanian White, Livny, Malhado De Alcobaca, Mangalitsa, Meishan, Middle White, Minokawa Buta, Minzhu, Mong Cai, Mora Romagnola, Moura, Mukota, Mulefoot, Murom, Myrhorod, Neijiang, Nero Dei Nebrodi, Ningxiang, North Caucasian, North Siberian, Norwegian Landrace, Norwegian Yorkshire, Ossabaw Island, Oxford Sandy and Black, Pakchong 5, Philippine Native, Pietrain, Poland China, Red Wattle, Semirechensk, Siberian Black Pied, Small Black, Small White, Spots, Surabaya Babi, Swabian-Hall, Swedish Landrace, Taihu Pig, Tamworth, Thuoc Nhieu, Tibetan, Tokyo-X, Tsivilsk, Turopolje, Ukrainian Spotted Steppe, Ukrainian White Steppe, Urzhum, Vietnamese Potbelly, Welsh, Wessex Saddleback, West French White, Windsnyer, Wuzishan, Yanan, Yorkshire Blue and White, or a combination thereof.

The methods described can improve gut microbiota, e.g., increase healthy microbiota bacterial species, in the pig receiving the feed described herein. A healthy gut microbiota includes high microbial diversity with increased number of beneficial species such as Lactobacillus and Bifidobacterium and reduced number of pathogenic species such as Escherichia coli, Salmonella, Campylobacter, Straphylococcus aureus, Treichinella, Toxoplasma gondii, Trichinella spiralis.

The methods described can improve gut morphology in the pig receiving the feed described herein. Gut morphology can be measured as the ratio of intestinal epithelium villus height to the crypt depth. An increase in said ratio indicates an improved gut morphology and improved intestinal nutrient absorption capacity.

The methods described can decrease tail biting in the pigs receiving the feed described herein. Tail baiting is measured by scoring tail lesions on the pig. A reduction in tail biting is indicated by a lower percentage of pigs with tail lesions or by a lower severity of tail lesions on average.

The methods described can decrease aggressive behavior in pigs receiving the feed described herein. Aggression and aggressive behavior is measured by skin lesion scoring and behavior observations. A reduction in aggression is indicated by a lower percentage of pigs with skin lesions or by a lower severity of lesions on average. Aggression and aggressive behavior may also be analyzed by the time spent by a pig in negative behavior (e.g., fighting, tail biting, mounting, belly nosing, manipulation of ears and paws, etc.). There is less aggression when pigs spend less time in negative behaviors relative to time spend in other behaviors. Time spent inactive is another indicator related to aggression. If pigs spend relatively more time inactive, they are calmer and less prone to aggression.

The methods described can decrease pre-weaning mortality of offspring of the sow, calculated as (dead offspring/(offspring born alive+added at fostering−removed at fostering))*100%, as compared to a corresponding method using swine feed does not include the insect oil. For example, the method can decrease pre-weaning mortality by 1% to 20%, 2% to 10%, or about 1%, 2%, 3, 4, 5, 6, 7, 8, 9, 10, 11, 12, 13, 14, 15, 16, 17, 18, 19%, or 20% as compared to a corresponding method using swine feed without the insect oil.

The methods described can increase livability of offspring of the sow, calculated as 1−((dead offspring+stillborn offspring)/(total offspring born+added at fostering−removed at fostering))*100%, as compared to a corresponding method using swine feed that does not include the insect oil. For example, the method can increase livability of offspring of the sow by 1% to 20%, 3 to 15%, or at least 1%, 2%, 3%, 4%, 5%, 6%, 7%, 8%, 9%, 10%, 11%, 12%, 13%, 14%, 15%, 16%, 17%, 18%, 19%, or 20% compared to a corresponding method using swine feed without the insect oil.

The methods described can increase average daily weight gain of an offspring of the sow being fed or of the piglet being fed, as compared to a corresponding method using swine feed that does not include the insect oil. For example, the method can increase average daily weight gain by 1% to 30%, 5% to 15%, or at least 1%, 2%, 3%, 4%, 5%, 6%, 7%, 8%, 9%, 10%, 11%, 12%, 13%, 14%, 15%, 16%, 18%, 20%, 22%, 24%, 26%, 28%, or 30% compared to a corresponding method using swine feed without the insect oil.

The methods described can decrease the number of stillborn offspring of the sow, as compared to a corresponding method using swine feed that does not include the insect oil. For example, the method can decrease the average number of stillborn offspring by 0.1% to 8%, 0.5% to 4%, or at least 0.1%, 0.2%, 0.4%, 0.6%, 0.8%, 1%, 1.2%, 1.4%, 1.6%, 1.8%, 2%, 2.2%, 2.4%, 2.6%, 2.8%, 3%, 3.2%, 3.4%, 3.6%, 3.8%, 4%, 4.5%, 5%, 5.5%, 6%, 6.5%, 7%, 7.5%, or 8% compared to a corresponding method using swine feed without the insect oil.

The methods described can increase average body weight at weaning of offspring of the sow, as compared to a corresponding method using swine feed that does not include the insect oil. For example, the method can increase the average weight at weaning by 1% to 30%, 5% to 15%, or at least 1%, 2%, 3%, 4%, 5%, 6%, 7%, 8%, 9%, 10%, 11%, 12%, 13%, 14%, 15%, 16%, 18%, 20%, 22%, 24%, 26%, 28%, or 30% compared to a corresponding method using swine feed without the insect oil. As used herein, “weaning weight” is the weight of a piglet when they are weaned off sow's milk or a milk replacement. The age at weaning for determining weaning weight may be between about 15 days and 30 days old, between about 16 and about 28 days old, or between about 17 and 21 days old. The age at weaning may be about 15, 16, 17, 18, 19, 20, 21, 22, 23, 24, 25, 26, 27, 28, 29 or 30 days old. The age at weaning may be less than 30, 29, 28, 27, 26, 25, 24, 23, 22, 21, 20, 19, 18, 17, or 16 days old.

The methods described can increase feed efficiency of the piglet, calculated as an increase in the ratio of body weight gain to feed consumed (gain:feed ratio) over a specified period of time, as compared to a corresponding method using swine feed that does not include the insect oil. Likewise, methods described can improve feed conversion of the piglet, calculated as a decrease in the ratio of feed consumed to body weight gain (feed:gain ratio). For example, the method can increase feed efficiency by 1% to 20%, 3 to 15%, or at least 1%, 2%, 3%, 4%, 5%, 6%, 7%, 8%, 9%, 10%, 11%, 12%, 13%, 14%, 15%, 16%, 17%, 18%, 19%, or 20%, compared to a corresponding method using swine feed without the insect oil. Likewise, the method can improve feed conversion by decreasing (feed:gain ratio) by 1% to 20%, 3 to 15%, or at least 1%, 2%, 3%, 4%, 5%, 6%, 7%, 8%, 9%, 10%, 11%, 12%, 13%, 14%, 15%, 16%, 17%, 18%, 19%, or 20% compared to a corresponding method using swine feed without the insect oil. Feed efficiency and feed conversion may be evaluated over 1, 2, 3, 4, 5, 6, or 7 days, 1, 2, 3, or 4 weeks, or over 1, 2, 6, or 12 months.

### Method of Making a Swine Feed

Various aspects of the present disclosure provide a method of making the swine feed described herein. The method includes combining the swine feed product described herein with another composition, such as a base feed, to form the swine feed. The method can also include adding insect oil to a swine feed to form the swine feed described herein.

The method can include combining a swine feed product with a base swine feed, to form the swine feed. The swine feed product includes insect oil that is about 0.1 wt % to 99.9 wt % of the swine feed product such that when added to a base feed the final swine feed includes about wt % to about 10 wt % insect oil.

### EXAMPLES

Various embodiments of the present invention can be better understood by reference to the following Examples which are offered by way of illustration. The present invention is not limited to the Examples given herein.

### Example 1— Insect Oil Effect on Nursery Piglets' Performance and Blood Parameters

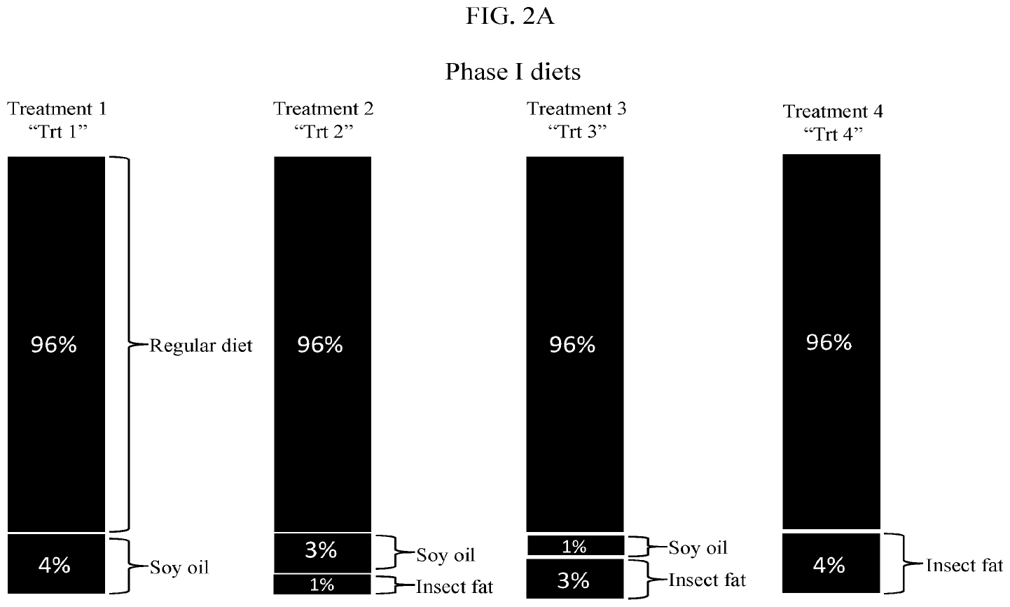

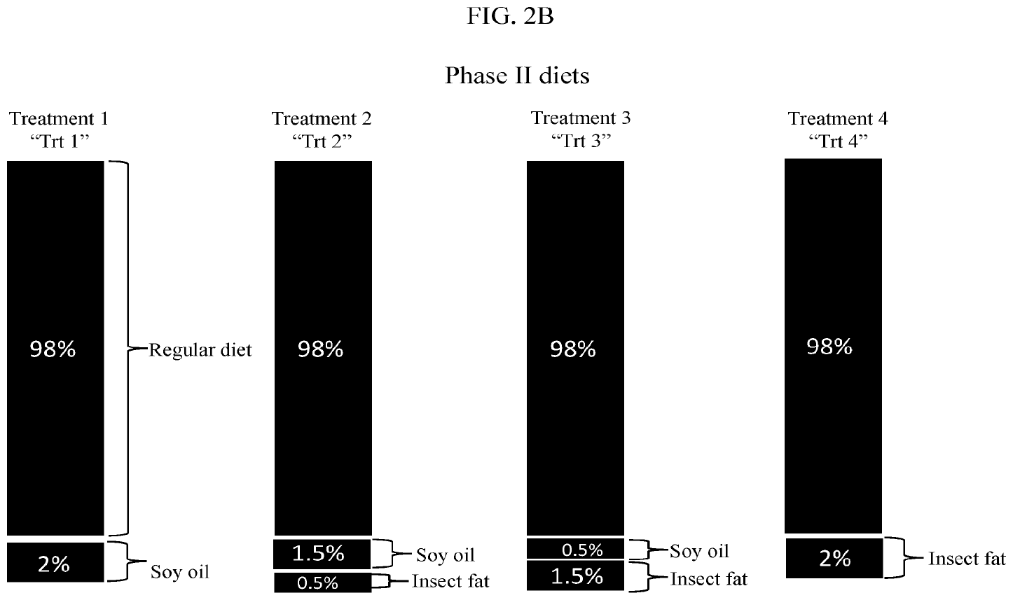

To study the dose effect of insect oil on nursery piglets, piglets were fed diets with various concentrations of fat extracted from Hermetia Illucens larvae. 120 post weaning (day 21) piglets blocked by weight were assigned to one of the four experimental treatments outlined in Table 2 and FIGS. 2A and 2B. Piglets were housed with 3 piglets per pen with 10 pens and 30 total piglets per treatment. The trial ran over 39 days over two phases. Phase 1 occurring over days of the trial, and Phase 2 occurring over days 14-39 of the trial. Parameters including growth performance (body weight, ADG, ADFI, G:F), mortality (number of deaths/culled piglets), stool quality (fecal score), and blood metabolites (e.g., Na, K, Cl, Ca, P, glucose, triglyceride, cholesterol, amylase, lipase, alkaline phosphatase (ALP), alanine aminotransferase (ALT), aspartate aminotransferase (AST), gamma-glutamyl transferase (GGT), total protein, albumin, creatinine, urea, creatinine kinase, and globulin) were tested throughout the trial.

TABLE 2
Piglet feed treatments

Inclusion level of Insect oil

| Treatment | Phase I (d 0-14) | Phase II (d 14-39) |
|---|---|---|
| 1 | — | — |
| 2 | 1% | 0.5% |
| 3 | 3% | 1.5% |
| 4 | 4% | 2% |

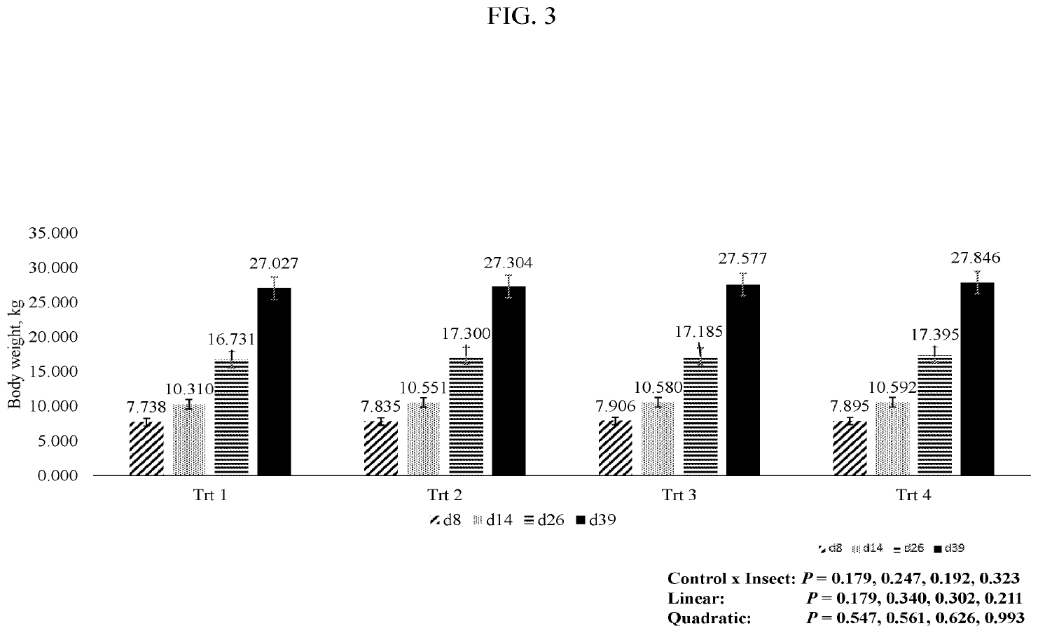

The inclusion of insect oil in the piglet feed did not impact body weight at any period (P>0.05). However, there was an increase in final body weight of Treatment 4 vs Treatment 1 piglets (3% increase in body weight, or approximately 819 g). See FIG. 3.

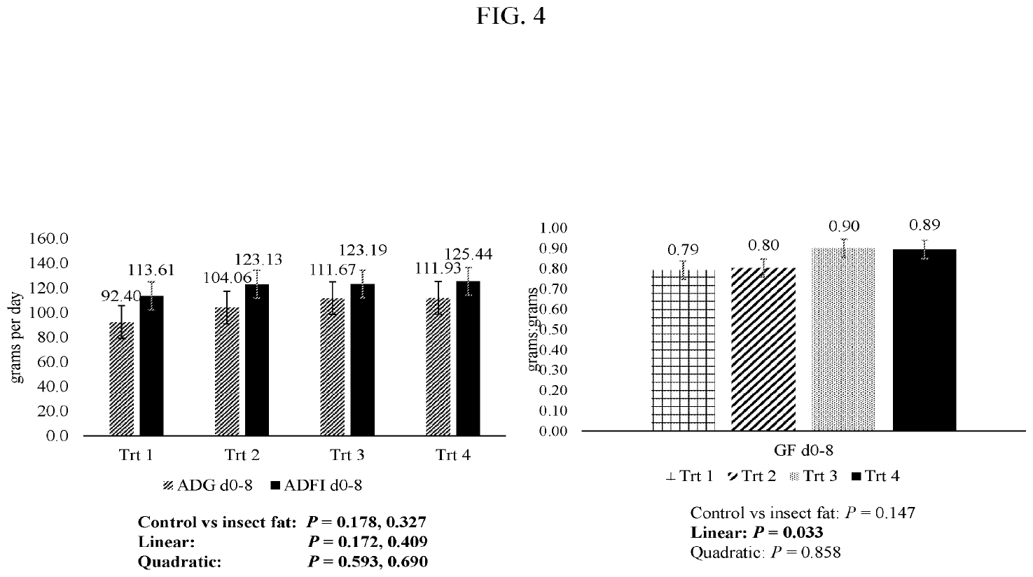

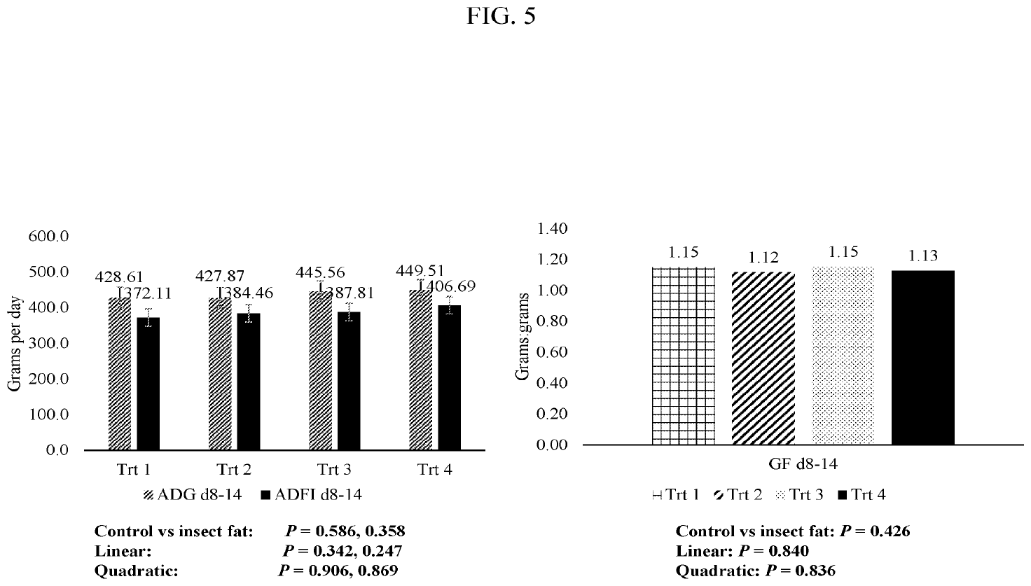

During the first week post weaning (days 0-8 of the trial, piglet age 21-29 days), there were no effects of feeding insect oil on ADG or ADFI. There were increases in ADG (up to 21%) and ADFI (up to 10%) with increasing levels of insect oil. There was a linear increase in feed efficiency with increasing levels of insect oil (P=0.03). See FIG. 4. The results of growth performance on days 8-14 of the trial are shown in FIG. 5.

In general, ADG is measured as (average weight out−average weight in)/days between in and out. Average weight is calculated as the total body weight divided by the number of animals weighed. ADFI is measured as average amount of feed consumed per piglet per day. The feed consumed is based on the reduction of feed in the feeder based on the starting amount of feed (e.g., feed consumed=starting feed amount−remaining feed amount), then divided by the number of piglets to determine average feed consumed per piglet.

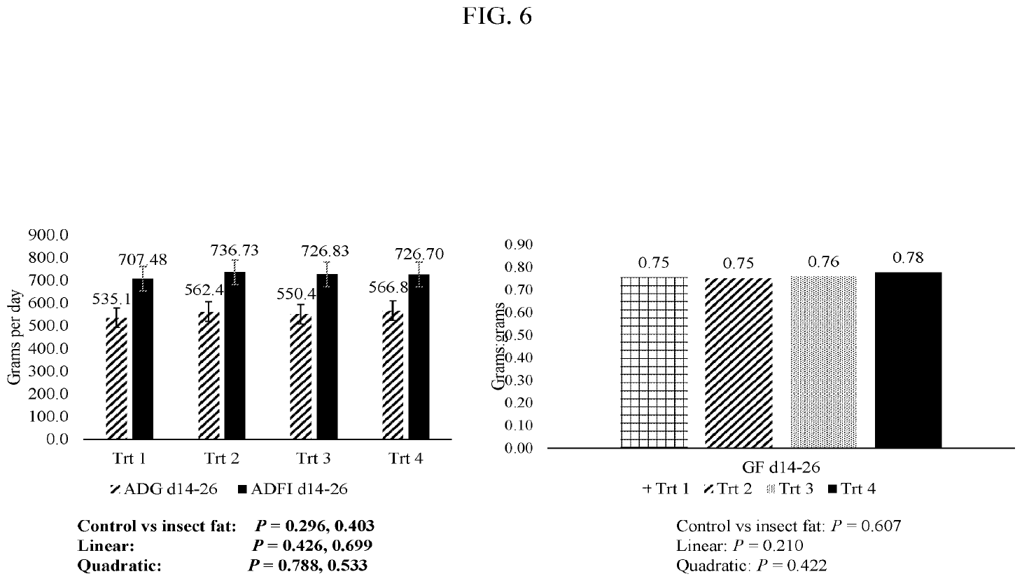

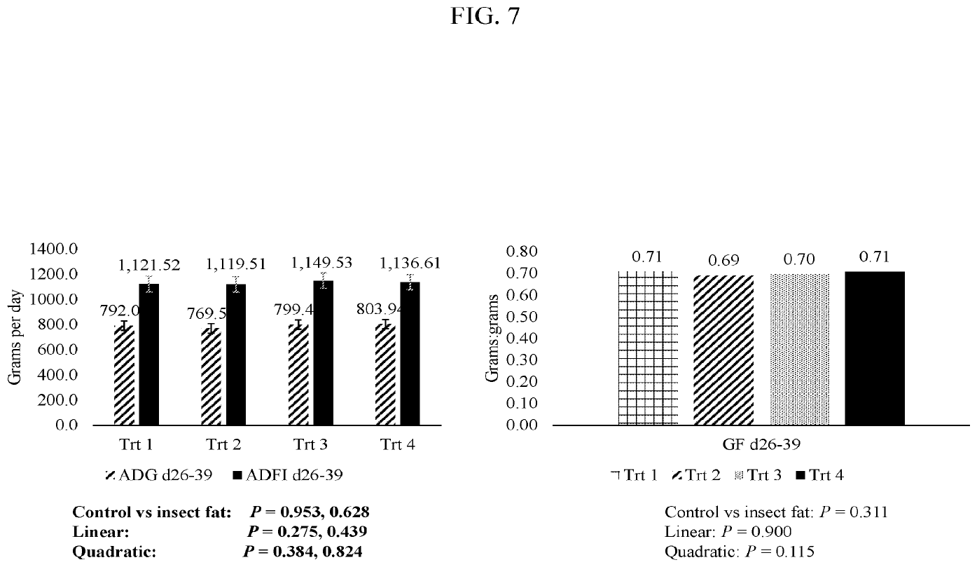

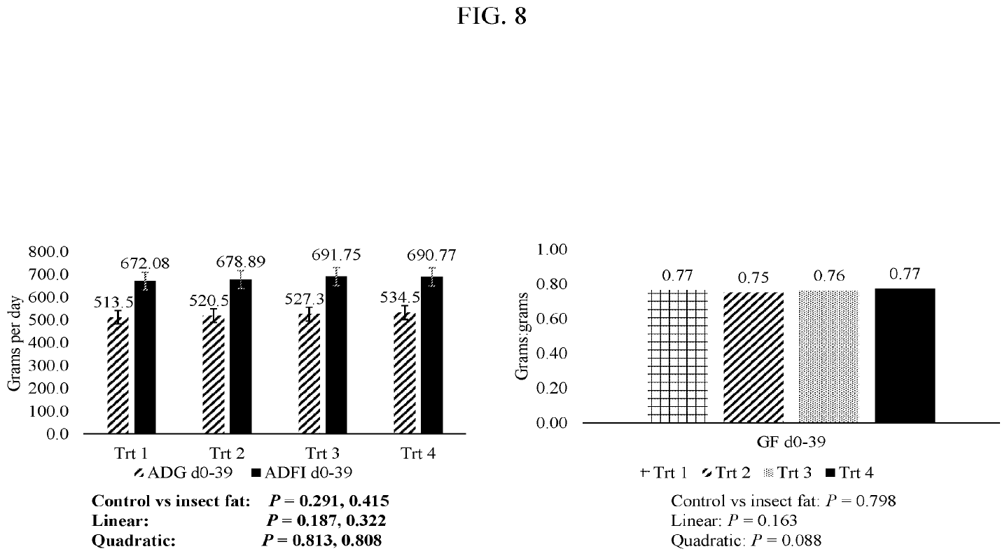

From day 14-26 of the trial (FIG. 6) and day 26-39 (FIG. 7), no differences in ADG, ADFI, or G:F were observed for any dietary treatment (P>0.05). Overall, there were no statistically significant differences in ADG, ADFI, and G:F observed for any dietary treatments observed in this study (P>0.05) See FIG. 8. However, there appeared to be a trend between increased inclusion of insect oil and increased ADG and ADFI, although the results were not statistically significant.

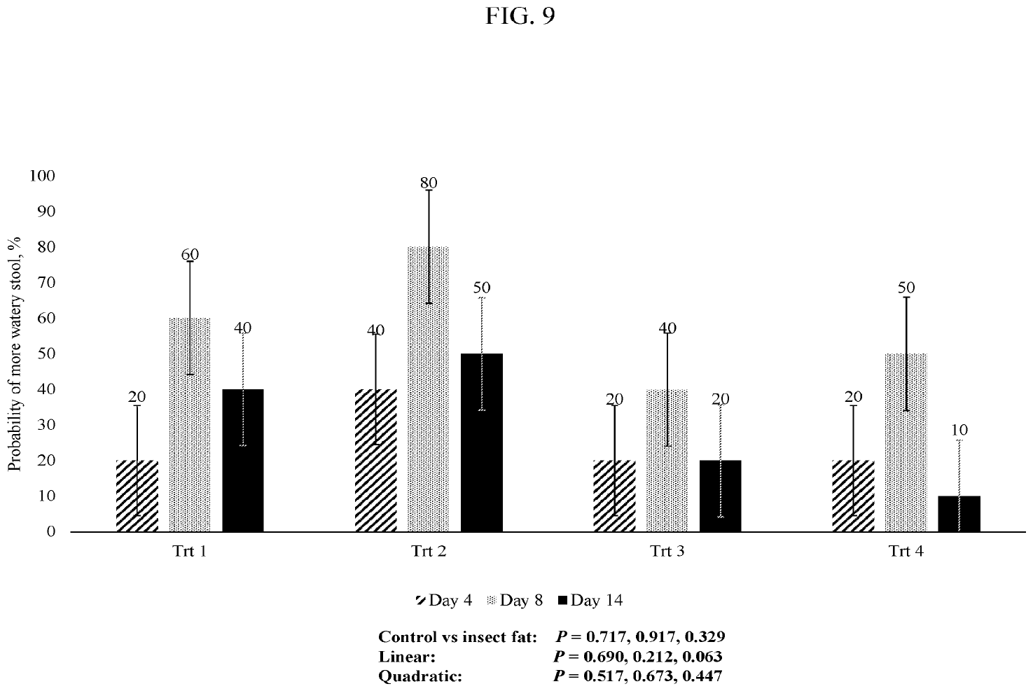

Fecal score for the piglets in the trial was based on a scale from 1 to 4 (1=firm/normal stool; 2=soft; 3=very soft; 4=watery diarrhea). All observations of fecal score were between 1 (normal) and 2 (soft). There were no differences in the probability of having a waterier stool among the various treatments (P>0.05). However, there was a tendency of linear reduction of probability of watery stool at day 14 of the trial with increasing inclusion of insect oil (P=0.06). FIG. 9.

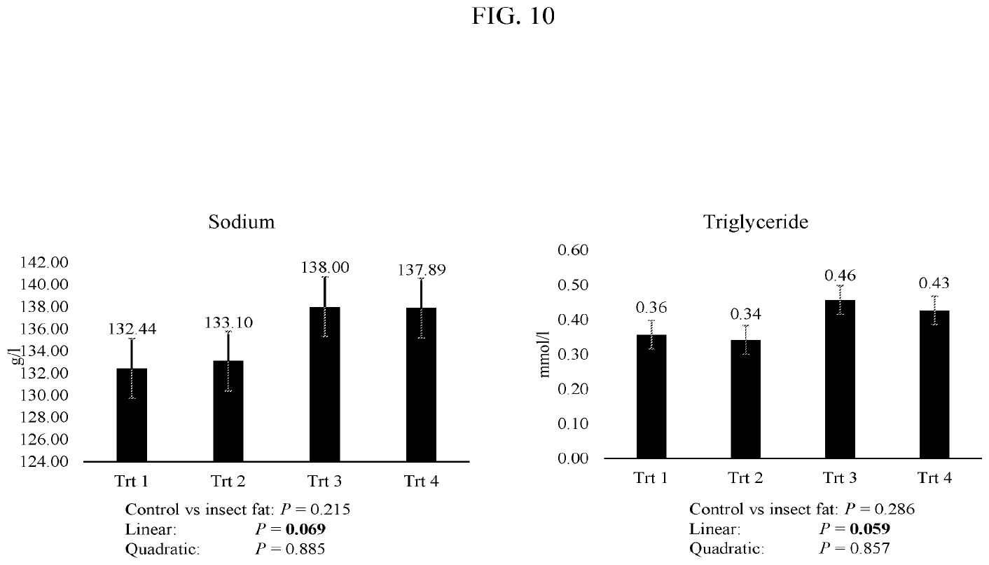

Blood samples were collected at day 8 of the trial, which is the end of the first week post weaning. Blood metabolite measurements are shown in Table 3. During the first week post weaning, there was an increase in ADFI of piglets fed increasing levels of insect oil. There was a linear increase in sodium and triglycerides with increasing levels of insect oil in the diets. FIG. 10. In comparison with long-chain fatty acids, MCFAs are expected to reduce serum triacylglycerol due to direct transportation to the portal vein without transformation of the MCFAs to triacylglycerol by lipoproteins. This is inconsistent with the results measured but may be explained by the quickly elevated feed intake post-weaning.

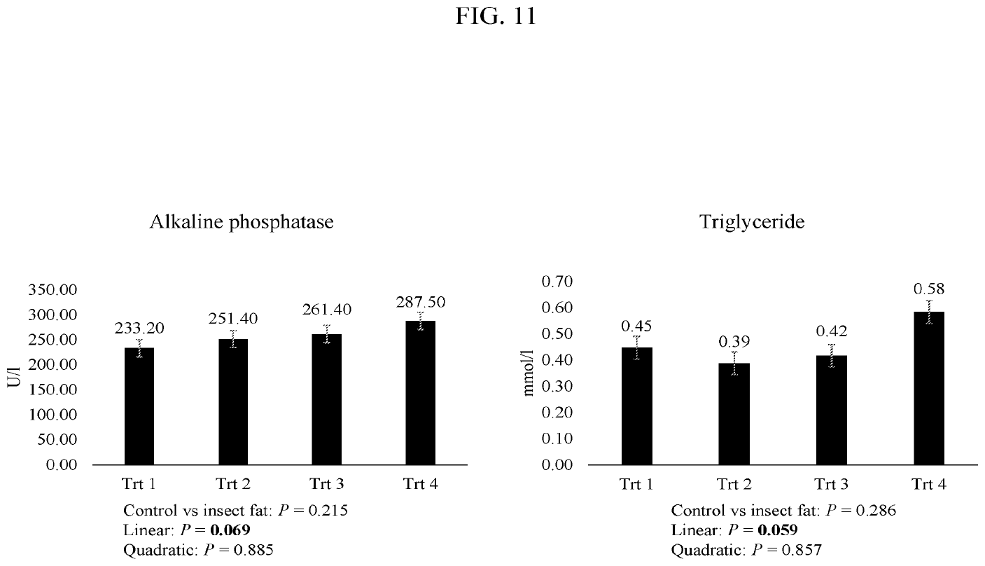

From day 14-26 of the trial, feeding patterns were comparable to the first week post-weaning in which greater feed intake was observed in piglets fed diets containing increasing levels of insect oil. There was a linear increase in alkaline phosphatase and a quadratic response in triglycerides with increasing levels of insect oil. FIG. 11. High levels of alkaline phosphatase may indicate either liver pathology due to obstruction of the bile duct or increased bone formation. This may indicate that bone growth may be greater than muscle growth in pigs fed feeds containing insect oil. Blood metabolite measurements in samples collected at day 26 of the trial are shown in Table 4.

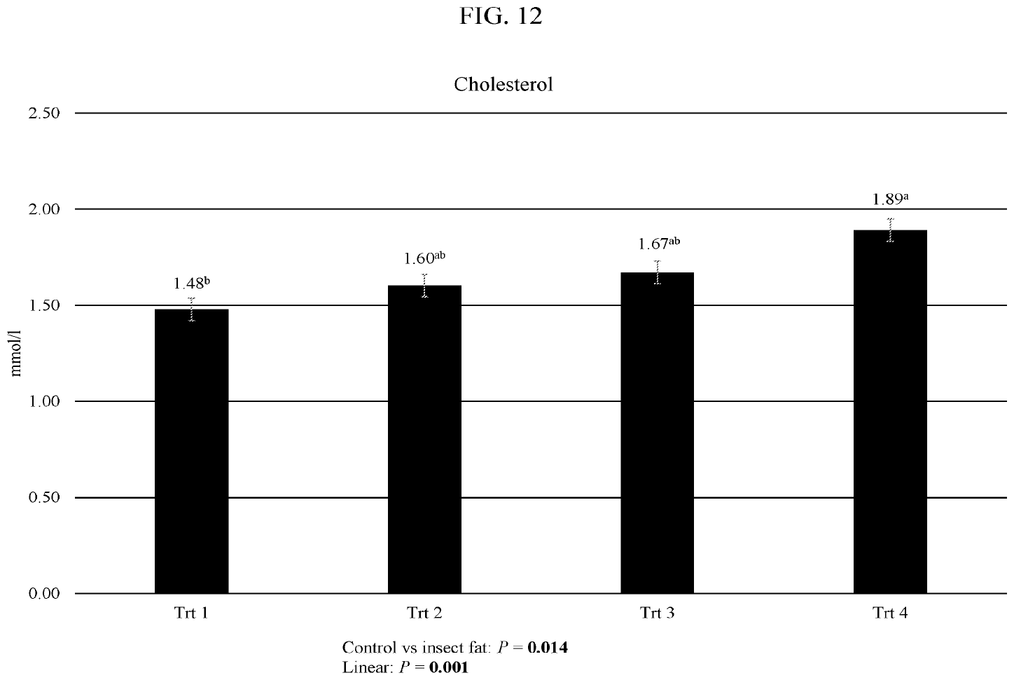

Table 5 shows blood metabolite measurements in samples from day 8 of the trial and corrected for body weight. Cholesterol levels increased linearly with inclusion of insect oil in the fed. FIG. 12.

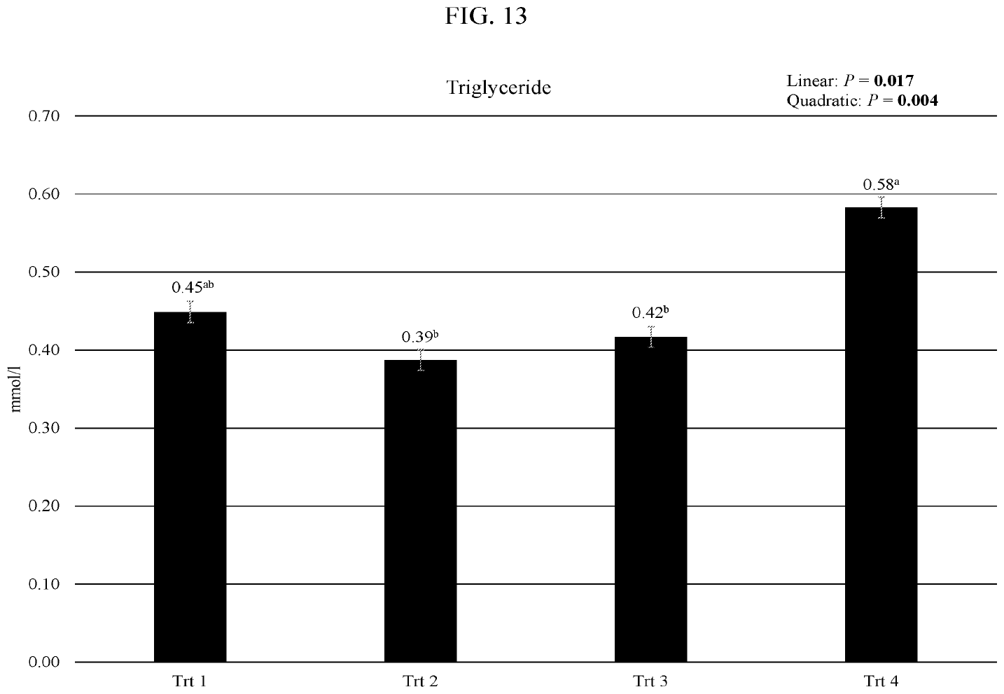

Similarly, Table 6 shows blood metabolites measured in samples from day 26 of the trial and corrected for body weight. These data demonstrate that triglyceride levels increased quadratically with increasing levels of insect oil in the feed. FIG. 13.

TABLE 3
Blood metabolites in samples collected at day 8 of the trial

| | | | | | | P-value | | | |
|---|---|---|---|---|---|---|---|---|---|
| | | Treatment | | | | Pairwise | Control × Insect | | |
| Parameter | Unit | 1 | 2 | 3 | 4 | comparison | oil | Linear | Quadratic |
| Alanine aminotransferase | U/l | 42.90 | 38.10 | 40.10 | 37.10 | 0.693 | 0.299 | 0.413 | 0.807 |
| Albumine | g/l | 31.69 | 31.94 | 32.31 | 31.79 | 0.985 | 0.820 | 0.883 | 0.754 |
| Alkaline phosphatase | U/l | 318.00 | 302.40 | 319.80 | 344.00 | 0.7361 | 0.894 | 0.411 | 0.455 |
| Amylase | U/l | 1338.10 | 1174.10 | 1689.70 | 1373.80 | 0.2366 | 0.718 | 0.301 | 0.670 |
| Aspartate aminotransferase | U/l | 43.50 | 34.50 | 35.60 | 40.10 | 0.5018 | 0.216 | 0.701 | 0.156 |
| Calcium | mmol/l | 2.45 | 2.32 | 2.43 | 2.42 | 0.8284 | 0.624 | 0.897 | 0.587 |
| Cholesterol | mmol/l | 1.60 | 1.60 | 1.67 | 1.74 | 0.8142 | 0.619 | 0.363 | 0.759 |
| Creatinine | umol/l | 78.00 | 73.00 | 71.30 | 72.90 | 0.8656 | 0.417 | 0.528 | 0.580 |
| Gamma-glutamyl transferase | U/l | 31.20 | 26.50 | 26.80 | 27.80 | 0.6958 | 0.253 | 0.512 | 0.365 |
| GLDH | U/l | 1.70 | 1.30 | 1.15 | 1.20 | 0.6542 | 0.263 | 0.350 | 0.600 |
| Glucose | mmol/l | 5.89 | 5.68 | 5.75 | 6.02 | 0.7155 | 0.776 | 0.645 | 0.292 |
| Lipase | U/l | 4.57 | 4.00 | 4.71 | 4.29 | 0.7493 | 0.670 | 0.924 | 0.883 |
| Phosphate | mmol/l | 2.68 | 2.49 | 2.67 | 2.65 | 0.6356 | 0.561 | 0.776 | 0.486 |
| Potassium | mmol/1 | 5.40 | 5.21 | 5.29 | 5.23 | 0.9337 | 0.552 | 0.740 | 0.753 |
| Sodium | mmol/l | 132.44 | 133.10 | 138.00 | 137.89 | 0.2861 | 0.215 | 0.069 | 0.885 |
| Total bilirubin* | umol/l | <1.7 | <1.7 | <1.7 | <1.7 | — | — | — | — |
| Total protein | g/l | 41.90 | 40.60 | 40.60 | 40.40 | 0.9254 | 0.504 | 0.591 | 0.755 |
| Triglyceride | mmol/l | 0.36 | 0.34 | 0.46 | 0.43 | 0.1694 | 0.286 | 0.059 | 0.857 |
| Urea | mmol/l | 2.11 | 1.87 | 1.99 | 2.09 | 0.8892 | 0.919 | 0.815 | 0.499 |

TABLE 4
Blood metabolites in samples collected at day 26 of the trial

| | | | | | | P-value | | | |
|---|---|---|---|---|---|---|---|---|---|
| | | Treatment | | | | Pairwise | Control × Insect | | |
| Parameter | Unit | 1 | 2 | 3 | 4 | comparison | oil | Linear | Quadratic |
| Alanine aminotransferase | U/l | 44.10 | 43.60 | 45.20 | 45.33 | 0.940 | 0.820 | 0.588 | 0.893 |
| Albumine | g/l | 31.08 | 32.07 | 31.82 | 32.19 | 0.990 | 0.773 | 0.806 | 0.956 |
| Alkaline phosphatase | U/l | 233.20 | 251.40 | 261.40 | 287.50 | 0.179 | 0.101 | 0.037 | 0.820 |
| Amylase | U/l | 1534.40 | 1458.10 | 1811.10 | 1483.67 | 0.426 | 0.797 | 0.642 | 0.460 |
| Aspartate aminotransferase | U/l | 45.50 | 41.70 | 34.80 | 38.11 | 0.643 | 0.310 | 0.275 | 0.588 |
| Calcium | mmol/l | 2.53 | 2.55 | 2.61 | 2.54 | 0.955 | 0.804 | 0.828 | 0.710 |
| Cholesterol | mmol/l | 1.92 | 1.97 | 1.94 | 1.97 | 0.991 | 0.818 | 0.897 | 0.960 |
| Creatinine | umol/l | 57.90 | 48.40 | 53.10 | 52.33 | 0.396 | 0.149 | 0.609 | 0.274 |
| Gamma-glutamyl transferase | U/l | 29.30 | 26.90 | 24.40 | 28.80 | 0.793 | 0.556 | 0.772 | 0.376 |
| GLDH | U/l | 1.40 | 1.10 | 1.90 | 1.46 | 0.517 | 0.860 | 0.436 | 0.866 |
| Glucose | mmol/l | 6.23 | 6.33 | 6.62 | 6.41 | 0.880 | 0.576 | 0.560 | 0.671 |
| Lipase | U/l | 4.00 | 3.83 | 3.40 | 4.67 | 0.379 | 0.952 | 0.567 | 0.144 |
| Phosphate | mmol/l | 2.89 | 3.00 | 3.04 | 3.00 | 0.927 | 0.519 | 0.618 | 0.672 |
| Potassium | mmol/l | 5.50 | 5.70 | 5.65 | 5.50 | 0.892 | 0.642 | 0.963 | 0.449 |
| Sodium | mmol/l | 137.10 | 136.20 | 136.30 | 135.11 | 0.995 | 0.834 | 0.812 | 0.977 |
| Total bilirubin* | umol/l | <1.7 | <1.7 | <1.7 | <1.7 | — | — | — | — |
| Total protein | g/l | 41.10 | 41.50 | 40.80 | 44.10 | 0.673 | 0.673 | 0.430 | 0.495 |
| Triglyceride | mmol/l | 0.45 | 0.39 | 0.42 | 0.58 | 0.005 | 0.710 | 0.016 | 0.005 |
| Urea | mmol/l | 1.80 | 1.57 | 1.34 | 1.61 | 0.773 | 0.554 | 0.643 | 0.440 |

TABLE 5
Blood metabolites in samples collected at day 8 of the trial and corrected for body weight

| | | | | | | P-value | | | |
|---|---|---|---|---|---|---|---|---|---|
| | | Treatment | | | | Pairwise | Control × Insect | | |
| Parameter* | Unit | 1 | 2 | 3 | 4 | comparison | oil | Linear | Quadratic |
| Alanine aminotransferase | U/l | 35.70 | 33.55 | 40.09 | 37.09 | 0.193 | 0.648 | 0.188 | 0.845 |
| Albumine | g/l | 31.68 | 30.78 | 32.32 | 31.80 | 0.815 | 0.969 | 0.617 | 0.866 |
| Alkaline phosphatase | U/l | 318.92 | 302.47 | 319.25 | 343.55 | 0.749 | 0.927 | 0.437 | 0.448 |
| Amylase | U/l | 1326.99 | 1173.23 | 1696.26 | 1379.22 | 0.218 | 0.664 | 0.268 | 0.646 |
| Aspartate aminotransferase | U/l | 36.22 | 34.50 | 35.65 | 40.15 | 0.658 | 0.892 | 0.411 | 0.366 |
| Calcium | mmol/l | 2.29 | 2.32 | 2.43 | 2.42 | 0.455 | 0.265 | 0.133 | 0.785 |
| Cholesterol | mmol/l | 1.48^{b} | 1.60^{ab} | 1.67^{ab} | 1.89^{a} | 0.010 | 0.014 | 0.001 | 0.558 |
| Creatinine | umol/l | 70.08 | 68.77 | 71.36 | 69.30 | 0.964 | 0.952 | 0.933 | 0.921 |
| Gamma-glutamyl transferase | U/l | 31.38 | 26.51 | 26.70 | 27.71 | 0.660 | 0.226 | 0.470 | 0.347 |
| GLDH | U/l | 1.10 | 1.35 | 1.16 | 1.02 | 0.781 | 0.800 | 0.596 | 0.535 |
| Glucose | mmol/l | 5.60 | 5.68 | 5.75 | 6.02 | 0.383 | 0.308 | 0.116 | 0.609 |
| Lipase | U/l | 4.59 | 3.94 | 3.76 | 4.27 | 0.512 | 0.196 | 0.502 | 0.165 |
| Phosphate | mmol/l | 2.50 | 2.49 | 2.67 | 2.65 | 0.286 | 0.312 | 0.085 | 0.927 |
| Potassium | mmol/l | 5.17 | 5.21 | 5.30 | 5.24 | 0.976 | 0.746 | 0.733 | 0.812 |
| Sodium | mmol/l | 132.33 | 133.11 | 138.06 | 137.93 | 0.280 | 0.205 | 0.067 | 0.867 |
| Total bilirubin** | umol/l | <1.7 | <1.7 | <1.7 | <1.7 | <1.7 | — | — | — |
| Total protein | g/l | 39.29 | 40.60 | 40.60 | 40.40 | 0.863 | 0.402 | 0.576 | 0.542 |
| Triglyceride | mmol/l | 0.36 | 0.34 | 0.42 | 0.39 | 0.405 | 0.528 | 0.218 | 0.812 |
| Urea | mmol/l | 2.08 | 1.88 | 1.96 | 2.12 | 0.914 | 0.769 | 0.861 | 0.514 |

TABLE 6
Blood metabolites in samples collected at day 26 of the trial and corrected for body weight

| | | | | | | P-value | | | |
|---|---|---|---|---|---|---|---|---|---|
| | | Treatment | | | | Pairwise | Control × Insect | | |
| Parameter | Unit | 1 | 2 | 3 | 4 | comparison | oil | Linear | Quadratic |
| Alanine aminotransferase | U/l | 43.93 | 43.67 | 45.22 | 45.39 | 0.933 | 0.757 | 0.550 | 0.926 |
| Albumine | g/l | 31.86 | 31.77 | 31.68 | 31.92 | 1.000 | 0.979 | 0.997 | 0.940 |
| Alkaline phosphatase | U/l | 234.70 | 250.20 | 248.46 | 256.35 | 0.667 | 0.242 | 0.313 | 0.767 |
| Amylase | U/l | 1528.24 | 1343.85 | 1444.27 | 1484.57 | 0.798 | 0.507 | 0.976 | 0.430 |
| Aspartate aminotransferase | U/l | 32.71 | 32.55 | 34.79 | 34.25 | 0.925 | 0.737 | 0.571 | 0.947 |
| Calcium | mmol/l | 2.56 | 2.54 | 2.61 | 2.52 | 0.951 | 0.996 | 0.981 | 0.779 |
| Cholesterol | mmol/l | 1.83 | 1.96 | 1.93 | 1.85 | 0.786 | 0.509 | 0.984 | 0.328 |
| Creatinine | umol/l | 55.18 | 47.98 | 52.87 | 51.87 | 0.524 | 0.306 | 0.878 | 0.376 |
| Gamma-glutamyl transferase | U/l | 26.81 | 26.65 | 24.27 | 28.44 | 0.860 | 0.933 | 0.937 | 0.540 |
| GLDH | U/l | 1.37 | 1.24 | 1.46 | 1.41 | 0.932 | 0.986 | 0.672 | 0.869 |
| Glucose | mmol/l | 6.29 | 6.31 | 6.61 | 6.39 | 0.908 | 0.716 | 0.660 | 0.730 |
| Lipase | U/l | 3.41 | 3.75 | 3.32 | 4.90 | 0.061 | 0.265 | 0.059 | 0.115 |
| Phosphate | mmol/l | 2.92 | 2.99 | 3.03 | 2.99 | 0.971 | 0.673 | 0.741 | 0.736 |
| Potassium | mmol/l | 5.52 | 5.69 | 5.65 | 5.50 | 0.912 | 0.722 | 0.905 | 0.482 |
| Sodium | mmol/l | 137.66 | 135.96 | 136.22 | 134.84 | 0.984 | 0.733 | 0.740 | 0.976 |
| Total bilirubin** | umol/l | <1.7 | <1.7 | <1.7 | <1.7 | <1.7 | — | — | — |
| Total protein | g/l | 41.55 | 41.31 | 40.74 | 41.56 | 0.988 | 0.875 | 0.929 | 0.781 |
| Triglyceride | mmol/l | 0.45^{ab} | 0.39^{b} | 0.42^{b} | 0.58^{a} | 0.005 | 0.754 | 0.017 | 0.004 |
| Urea | mmol/l | 1.73 | 1.59 | 1.35 | 1.64 | 0.662 | 0.450 | 0.560 | 0.339 |

There was no piglet mortality throughout the trial, and therefore mortality rate could not be measured. This is an indication of the high quality of the piglets, feed, and other trial conditions.

During the lactation phase, piglets offered different feeds to choose from showed a slight preference for feeds without insect oil (data not shown). During the nursery phase, piglets were not offered a choice in feeds and, in general, feed intake and weight gain increased with increasing insect oil in the feed. The greatest effects on performance were observed during the first week post-weaning (trial days 0-8), which is the most critical period for nursery pigs. In this first week post-weaning there was a linear improvement in feed efficiency with increasing levels of insect oil in the piglet feed. The lack of statistically significant effects on the insect oil on growth performance, stool quality, and mortality may be due to the low challenge and low stress conditions of the trial. Under harsher challenge conditions, the benefits of the insect oil in the feed will likely be more apparent.

Overall, compared to the control feeds, the inclusion of insect oil of up to 4% in phase I and 2% in phase II did not affect overall performance and stool quality. Effects of feeding insect oil were observed only in the first week with linear improvement in feed efficiency with increasing levels of insect oil. These data also demonstrate that piglets can safely be fed diets with up to 4% insect oil at 0-14 days post weaning and up to 2% 14-39 days post weaning.

### Example 2

This example describes a two-part trial that observes (i) the effects of insect oil in the lactation and neonatal diets on sow and piglet performance; and (ii) the post-weaning effect of insect oil in lactation, neonatal, and nursery diet on piglet growth performance. The treatment diets used in the two parts (Lactation Phase and Nursery Phase) of the trial are outlined in Table 7. The trial was designed the use factorial 2×2 statistical analyses.

TABLE 7
Phase I (Lactation Phase) and Phase II (Nursery Phase) Diets

| | Lactation Phase | | Nursery Phase | |
|---|---|---|---|---|
| Treatment No. | Sow feed | Creep feed | Phase I feed | Phase II feed |
| A | Control | Control | Control | Control |
| B | Control | Insect | Insect | Insect |
| | | oil (3%) | oil (2.5%) | oil (1.5%) |
| C | Insect | Control | Control | Control |
| | oil (2%) | | | |
| D | Insect | Insect | Insect | Insect |
| | oil (2%) | oil (3%) | oil (2.5%) | oil (1.5%) |

For the lactation phase of the trial, 24 litters inclusive of both the sow and piglets were blocked by parity (i.e., the age of the sow). Sows were fed experimental diets either with or without the insect oil. Piglets were offered creep feed, either with or without insect oil, in bowls in additional to any sow's milk they receive. The lactation phase lasted 21 days, and data on growth performance was measured on day 21. Additionally, blood samples were collected from the piglets at day 18. Parameters measured include growth performance (body weight (BW), BW gain, and feed intake (FI)) and blood metabolites.

Sow performance markers are shown in Table 8. During lactation, the feed intake of the sows fed diets with insect oil was 4.2% lower and the body weight loss of these sows was greater than sows fed control diets (9.6% loss on insect oil diet vs. 1.8% loss on control diets). However, no differences were observed in the sows' farrowing performance itself.

TABLE 8
Sow performance markers

| | Sow feed | | |
|---|---|---|---|
| Response Variable | Control | Insect Oil | P-value |

Parameters before cross fostering

| | | | |
|---|---|---|---|
| Total birth weight, kg | 20.010 | 21.035 | 0.433 |
| Total born | 17.8 | 17.1 | 0.681 |
| Average total birth weight, kg | 1.150 | 1.243 | 0.207 |
| Total alive | 1.10 | 1.27 | 0.191 |
| Total born alive | 16.71 | 15.83 | 0.498 |
| Average live weight | 1.17 | 1.27 | 0.191 |
| Stillborn | 1.05 | 1.42 | 0.467 |
| Stillborn % | 6.30 | 8.25 | 0.504 |
| Mortality | 2.23 | 1.64 | 0.470 |
| Backfat in, mm | 18.92 | 20.08 | 0.459 |
| Days pre-farrowing | 6.97 | 6.74 | 0.652 |
| ADFI pre-farrowing | 2.65 | 2.78 | 0.275 |
| Days post-farrowing | 23.99 | 23.68 | 0.572 |
| ADFI post-farrowing | 6.00 | 5.81 | 0.591 |

Parameters after cross fostering

| | | | |
|---|---|---|---|
| Backfat in (d 108), mm | 18.63 | 21.15 | 0.086 |
| Backfat out, mm | 15.56 | 16.71 | 0.311 |
| Backfat loss, % | 15.34 | 20.82 | 0.114 |
| BW in, kg | 276.0 | 273.4 | 0.754 |
| BW in corrected piglets amniotic, kg | 251.5 | 249.0 | 0.782 |
| BW out, kg | 247.2 | 226.5 | 0.036 |
| BW loss, % | 1.84 | 9.62 | 0.002 |
| Total sow FI post-farrowing, kg | 139.0 | 133.2 | 0.374 |

Bold font indicates P-value below 0.05

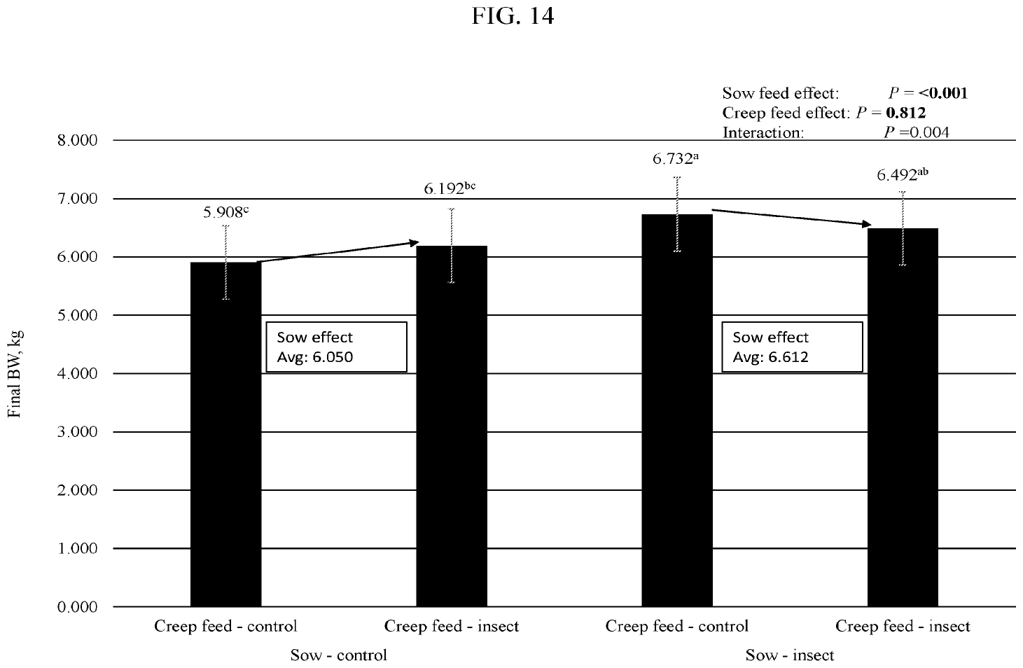

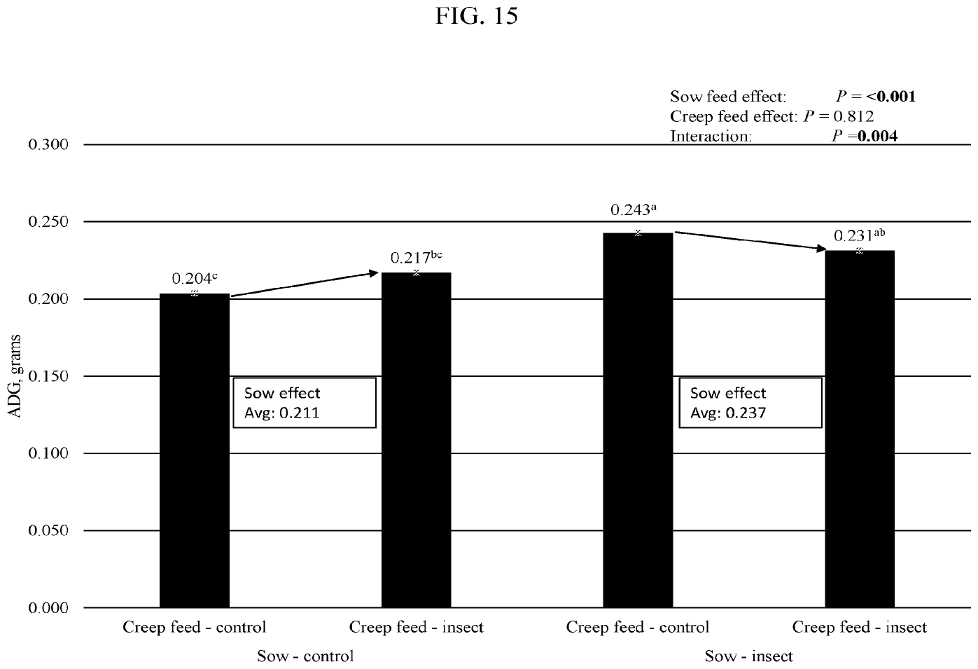

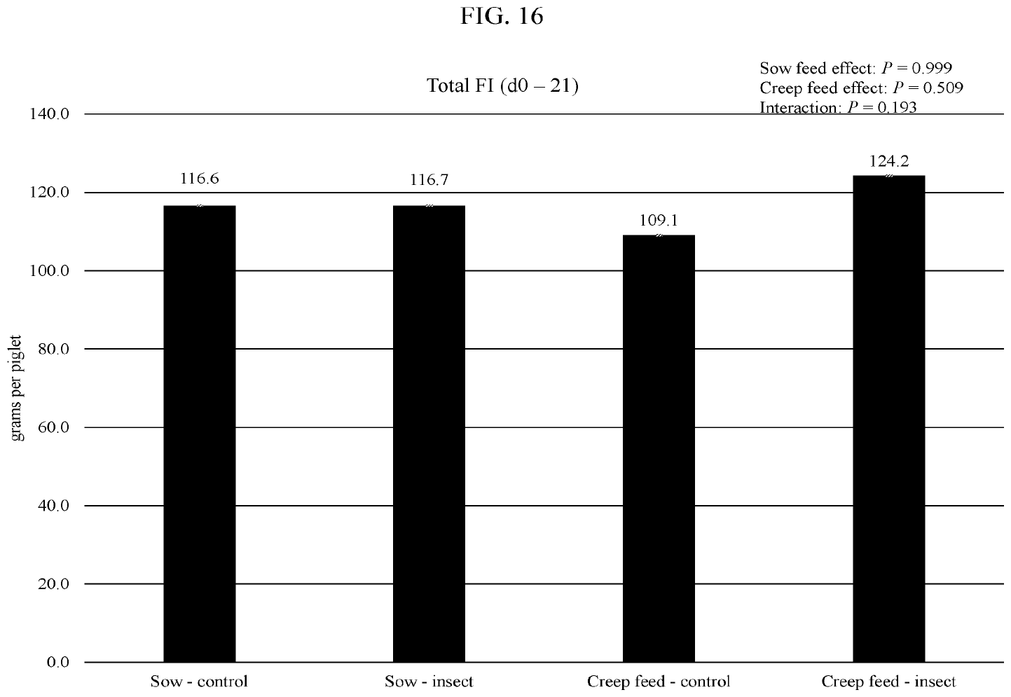

FIGS. 14, 15, and 16 show BW, ADG, and total FI (creep-feed) growth performance results, respectively, for the piglets in the lactation phase of the trial. Final BW and ADG were 9% and 13% higher, respectively, in litters from sows fed insect oil. This demonstrates that the nutritional benefits from the sows milk are greater than any nutritional benefit of the creep feeds containing insect oil. Additionally, positive effects on BW and ADG were also observed when creep feed containing insect oil was fed to piglets of lactating sows fed the control feed. There was no difference in total FI of creep feed consumed by piglets and milk consumption was not measured.

Table 9 shows blood metabolite data in samples collected at day 18 of the trial and corrected for body weight. All blood parameters were within normal range for pigs with no metabolic issues observed. The correction/normalization of blood parameters based on feed intake was not possible due to creep feed intake being measured for the litter as a whole (not based on individual piglets) and milk intake was not measured. The blood metabolite parameters were normalized for piglet body weight.

TABLE 9
Blood metabolites in samples collected at day 18 of the trial and corrected for body weight

| | | Treatment | | | | | | |
|---|---|---|---|---|---|---|---|---|
| | | Sow feed | | Piglet feed | | P-value | | |
| Parameter* | Unit | Control | Insect | Control | Insect | Sow feed | Piglet feed | Interaction |
| Alanine aminotransferase | U/l | 39.25 | 43.54 | 41.31 | 41.49 | 0.222 | 0.938 | 0.213 |
| Albumin | g/l | 33.57 | 30.03 | 31.68 | 31.92 | 0.051 | 0.841 | 0.370 |
| Alkaline phosphatase | U/l | 693.73 | 648.78 | 642.76 | 699.75 | 0.667 | 0.409 | 0.665 |
| Amylase | U/l | 2,566.77 | 2,897.72 | 2,564.76 | 2,899.73 | 0.344 | 0.149 | 0.829 |
| Aspartate aminotransferase | U/l | 39.11 | 43.02 | 41.28 | 40.84 | 0.530 | 0.915 | 0.709 |
| Calcium | mmol/l | 2.76 | 2.62 | 2.67 | 2.70 | 0.026 | 0.392 | 0.865 |
| Cholesterol | mmol/l | 4.35 | 4.49 | 4.40 | 4.43 | 0.753 | 0.916 | 0.397 |
| Creatinine | umol/l | 78.23 | 74.60 | 77.29 | 75.55 | 0.346 | 0.492 | 0.413 |
| Gamma-glutamyl transferase | U/l | 38.42 | 30.67 | 32.27 | 36.81 | 0.149 | 0.198 | 0.100 |
| GLDH | U/l | 1.92 | 1.79 | 1.73 | 1.97 | 0.870 | 0.708 | 0.268 |
| Glucose | mmol/l | 6.56 | 6.89 | 6.59 | 6.86 | 0.296 | 0.204 | 0.465 |
| Lipase | U/l | 4.90 | 4.77 | 4.81 | 4.86 | 0.737 | 0.873 | 0.038 |
| Phosphate | mmol/l | 3.23 | 3.24 | 3.16 | 3.31 | 0.891 | 0.015 | 0.054 |
| Potassium | mmol/l | 5.04 | 4.86 | 4.88 | 5.02 | 0.460 | 0.382 | 0.829 |
| Sodium | mmol/1 | 137.68 | 137.67 | 137.41 | 137.95 | 0.994 | 0.579 | 0.424 |
| Total bilirubin | umol/l | 5.19 | 4.88 | 4.93 | 5.14 | 0.710 | 0.708 | 0.222 |
| Total protein | g/l | 47.71 | 41.56 | 44.78 | 44.49 | 0.003 | 0.815 | 0.955 |
| Triglyceride | mmol/l | 1.01 | 1.40 | 1.09 | 1.32 | 0.118 | 0.144 | 0.484 |
| Urea | mmol/l | 1.53 | 1.42 | 1.47 | 1.48 | 0.613 | 0.961 | 0.582 |

Italics indicate P-value below 0.05; Bold indicates that the measured metabolites are different when either sows or piglets were fed different treatment groups showing an effect of feeding insect oil to said sows or piglets in nursery pigs at day 18.

For the nursery phase of the trial, 288 piglets blocked by weight were assigned to one of four experimental treatments. Pigs were housed with 6 pigs per pen with 12 replicate pens and 72 total pigs per treatment. The nursery phase portion of the trial lasted 38 days and included two separate dietary phases: phase I over days 0-14 of the nursery phase and phase II over days 14-38 of the nursery phase. Parameters measured include growth performance, mortality, stool quality, and blood metabolites. Data were analyzed as factorial 2×2 due to possible remaining effects from feeding sows with insect oil on treatments 3 and 4. Initial BW was added in the model to reduce effects from the lactation phase of the trial. The diets used in the nursery phase are outlined in Table 10.

TABLE 10
Nursery Phase trial diets

Inclusion level of Insect oil

| Treatment | Phase I (d 0-14) | Phase II (d 14-39) |
|---|---|---|
| 1 | — | — |
| 2 | 2.5% | 1.5% |
| 3 | — | — |
| 4 | 2.5% | 1.5% |

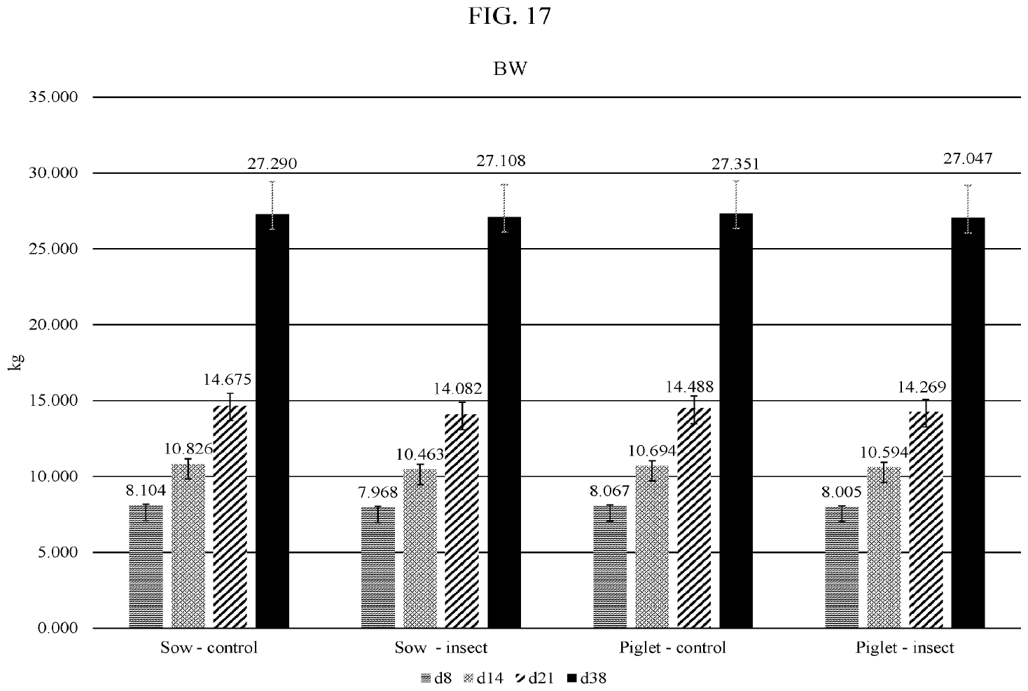

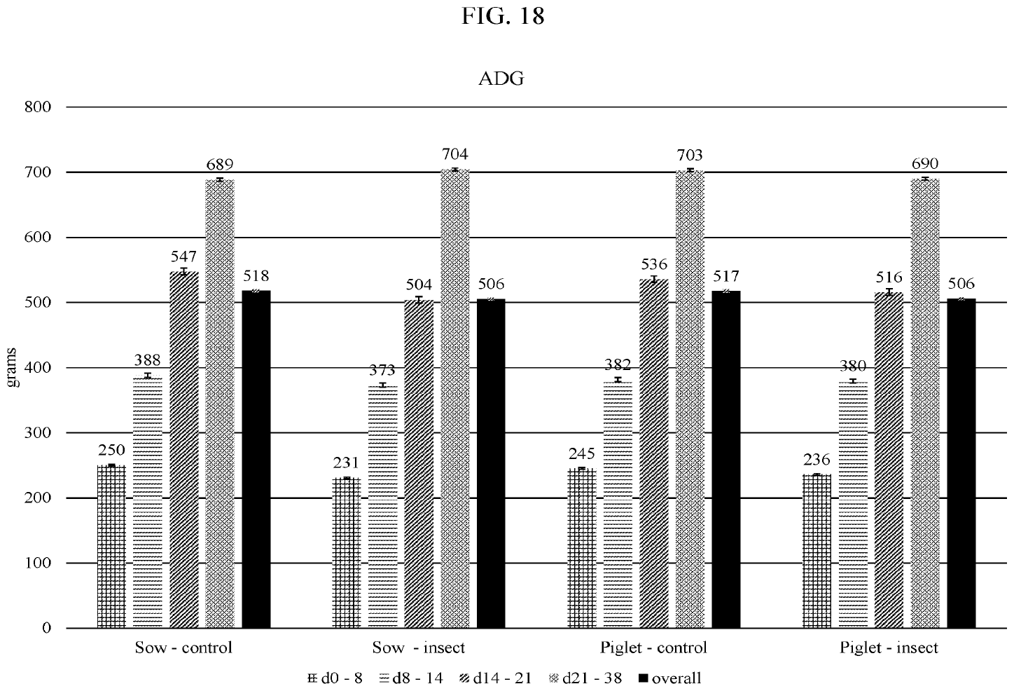

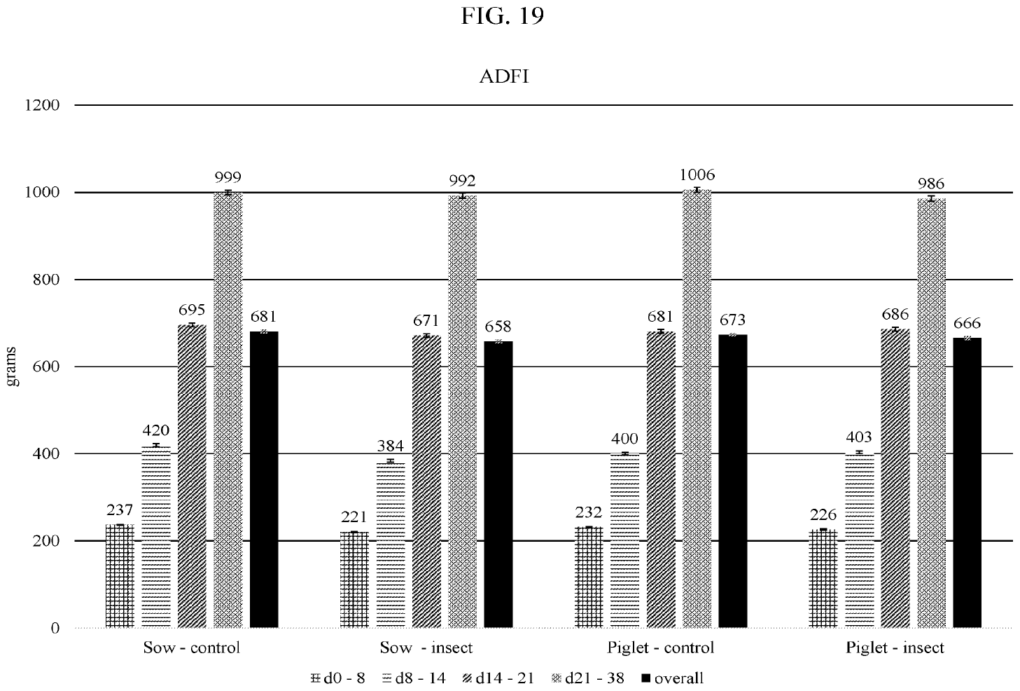

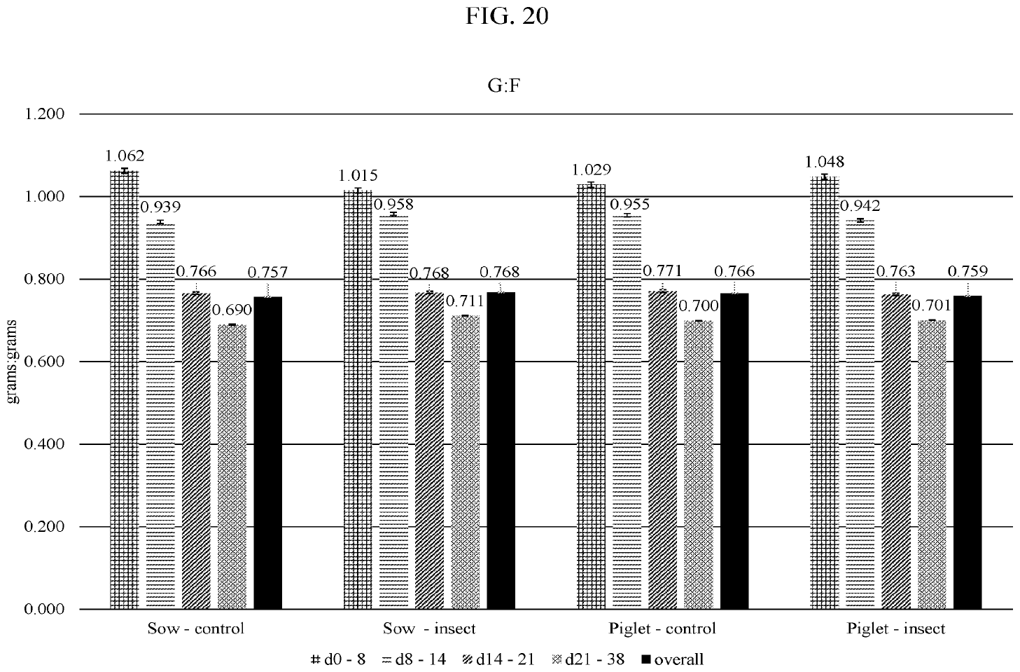

The P-values of treatment effects on body weight, ADG, ADFI, and feed efficiency growth performance parameters are shown in Tables 11, 12, 13, and 14, respectively. The actual data of body weight, ADG, ADFI, and feed efficiency performance parameters are shown in in FIGS. 17, 18, 19 and 20, respectively. No difference was observed among treatments, either piglets fed diets with or without insect oil or the remaining effects from sows fed insect oil during lactation. However, the levels of insect oil in the nursery phase diets was determined prior to the dose response results obtained in Example 1. It is expected the inclusion of a higher level insect oil in the feed would have a more significant outcome in this trial.

TABLE 11
Insect oil effect on body weight

P-value

| Effect | D 8 | D 14 | D 21 | D 38 |
|---|---|---|---|---|
| Sow feed | 0.171 | 0.153 | 0.136 | 0.752 |
| Piglet feed | 0.432 | 0.608 | 0.470 | 0.518 |
| Interaction | 0.474 | 0.931 | 0.387 | 0.631 |

TABLE 12
Insect oil effect on ADG

P-value

| Effect | D 0-8 | D 8-14 | D 14-21 | D 21-38 | D 0-38 |
|---|---|---|---|---|---|
| Sow feed | 0.171 | 0.554 | 0.115 | 0.403 | 0.456 |
| Piglet feed | 0.432 | 0.913 | 0.376 | 0.399 | 0.379 |
| Interaction | 0.474 | 0.640 | 0.454 | 0.817 | 0.767 |

TABLE 13
Insect oil effect on ADFI

P-value

| Effect | D 0-8 | D 8-14 | D 14-21 | D 21-38 | D 0-38 |
|---|---|---|---|---|---|
| Sow feed | 0.230 | 0.170 | 0.430 | 0.821 | 0.325 |
| Piglet feed | 0.623 | 0.873 | 0.826 | 0.407 | 0.673 |
| Interaction | 0.645 | 0.259 | 0.950 | 0.691 | 0.708 |

TABLE 14
Insect oil effect on feed efficiency

P-value

| Effect | D 0-8 | D 8-14 | D 14-21 | D 21-38 | D 0-38 |
|---|---|---|---|---|---|
| Sow feed | 0.179 | 0.483 | 0.937 | 0.056 | 0.109 |
| Piglet feed | 0.482 | 0.554 | 0.633 | 0.890 | 0.239 |
| Interaction | 0.440 | 0.425 | 0.112 | 0.230 | 0.149 |

Blood metabolite results are shown in Table 15. All blood parameters were in normal ranges and no metabolic issues were observed. There were no differences in parameters directly related to fat metabolism (e.g., cholesterol and lipase). These results are consistent with the results reported in Example 1 and confirm the expected results based on the level of insect oil being within the ranges tested in Example 1.

Overall, this trial demonstrates that feeding sows with insect oil throughout lactation phase is more effective to improve growth performance of piglets than feeding piglets insect oil through a creep feed, although the inclusion of insect oil in the creep feed is also beneficial. During the nursery phase, piglets from litters in which the sows were fed insect oil did not present better growth performance than piglets from litters in which the sows were fed the control diet. However, if feeding sows with insect oil results in weaning piglets with greater body weight at weaning, this likely reduces the period until pigs reach delivery weight at the end of the nursery.

TABLE 15
Blood metabolites in samples collected at day 7 of the nursery
phase of the trial and corrected for body weight

| | | Treatment | | | | | | |
|---|---|---|---|---|---|---|---|---|
| | | Sow feed | | Piglet feed | | P-value | | |
| Parameter | Unit | Control | Insect | Control | Insect | Sow feed | Piglet feed | Interaction |
| Alanine aminotransferase | U/l | 38.84 | 42.50 | 41.62 | 39.72 | 0.228 | 0.444 | 0.809 |
| Albumine | g/l | 30.88 | 29.07 | 30.47 | 29.48 | 0.150 | 0.330 | 0.485 |
| Alkaline phosphatase | U/l | 330.63 | 429.02 | [symbol] | [symbol] | <0.001 | 0.049 | 0.484 |
| Amylase | U/l | 2299.76 | 2917.58 | 2443.77 | 2773.56 | 0.034 | 0.149 | 0.833 |
| Aspartate aminotransferase | U/l | 35.89 | 41.25 | 38.09 | 39.04 | 0.178 | 0.766 | 0.744 |
| Calcium | mmol/l | 2.59 | 2.60 | 2.61 | 2.58 | 0.865 | 0.660 | 0.732 |
| Cholesterol | mmol/l | 1.81 | 1.87 | 1.80 | 1.88 | 0.529 | 0.340 | 0.691 |
| Creatinine | umol/l | 72.90 | 66.81 | [symbol] | [symbol] | 0.177 | 0.045 | 0.763 |
| Gamma-glutamyl transferase | U/l | 40.59 | 29.05 | 32.73 | 36.91 | 0.010 | 0.222 | 0.067 |
| GLDH | U/l | 1.35 | 1.35 | 1.32 | 1.38 | 0.978 | 0.726 | 0.668 |
| Glucose | mmol/l | 6.08 | 6.00 | 5.97 | 6.11 | 0.696 | 0.476 | 0.326 |
| Lipase | U/l | 4.30 | 4.33 | 4.19 | 4.44 | 0.944 | 0.358 | 0.786 |
| Phosphate | mmol/l | 3.09 | 3.13 | 3.08 | 3.14 | 0.583 | 0.447 | 0.653 |
| Potassium | mmol/l | 5.18 | 5.29 | 5.22 | 5.25 | 0.400 | 0.825 | 0.405 |
| Sodium | mmol/l | 141.41 | 138.65 | 140.13 | 139.93 | 0.099 | 0.886 | 0.956 |
| Total bilirubin* | umol/l | — | — | — | — | — | — | — |
| Total protein | g/l | 43.69 | 41.23 | 42.73 | 42.19 | 0.017 | 0.507 | 0.576 |
| Triglyceride | mmol/l | 0.42 | 0.40 | 0.39 | 0.43 | 0.737 | 0.232 | 0.851 |
| Urea | mmol/l | 1.25 | 0.92 | 1.30 | 0.87 | 0.420 | 0.177 | 0.779 |

Bold text indicates P-value below 0.05; italics indicate that the metabolites measured were different when sows were fed different treatments showing an effect of feeding insect oil to sows on nursery pigs at day 7; bold italics indicate that the metabolites measured were different when piglets were fed different treatments showing an effect of feeding insect oil to piglets.

### Example 3—Insect Oil and Palm Kernel Oil Effect on Nursery Piglets' Performance

To study the effect of insect oil and palm kernel oil on nursery piglets, piglets were fed diets with oil extracted from Hermetia Illucens larvae, or with palm kernel oil (PKO). The effects of insect oil and palm kernel oil were compared to that of soy oil. Post weaning (day 21) 160 piglets blocked by weight were assigned to one of the three experimental treatments outlined in Table 16. Piglets were housed with 5 piglets per pen, with 10 or 11 pens and 50 or 55 total piglets per treatment. The trial ran over 14 days. Parameters measured included growth performance (body weight, ADG, ADFI, G:F), mortality (number of deaths/culled piglets), and stool quality (fecal score).

TABLE 16
Piglet feed treatments

| Treatment | Oil source inclusion |
|---|---|
| 1 | Soy oil 3% |
| 2 | Palm kernel oil 1.5% + soy oil 1.5% |
| 3 | Insect oil 1.5% + soy oil 1.5% |

The inclusion of insect oil in the piglet feed did not impact body weight at any period (P>0.05). During the first week post weaning (days 0-7 of the trial, piglet age 21-28 days), there were no significant effects of either feeding insect oil or palm kernel oil on ADG, ADFI, and G:F. Both ADG and ADFI did increase numerically with both oil sources (insect and PKO). Feeding insect oil numerically increased ADFI by 5.6% and ADG by 7.6%. Feeding PKO numerically increased ADFI by 4.8% and ADG by 4.9%. See Table 17. The results of growth performance on days 8-14 of the trial are also shown in Table 17 (ADGc, ADFIc, and GFc indicate values corrected for piglets removed from the trial between time periods). During this week, no significant effects on piglet performance were observed by feeding insect oil nor palm kernel oil.

TABLE 17

| | Control | PKO 1.5% | Change v | Insect oil 1.5% | Change v | Standard | |
|---|---|---|---|---|---|---|---|
| | soy oil 3% | soy oil 1.5% | control | soy oil 1.5% | control | Error | P value |
| BW, d 7 | 8.37 | 8.46 | | 8.51 | | 0.062 | 0.2535 |
| BW, d 14 | 11.17 | 11.24 | | 11.30 | | 0.122 | 0.7596 |
| CV, d 7 | 5.41 | 5.15 | | 4.73 | | 0.609 | 0.6347 |
| CV, d 14 | 5.99 | 6.17 | | 6.35 | | 0.697 | 0.9274 |

d 0-7

| | | | | | | | |
|---|---|---|---|---|---|---|---|
| ADG | 0.274 | 0.288 | | 0.295 | | 0.009 | 0.2535 |
| ADGc | 0.274 | 0.288 | 4.9% | 0.295 | 7.6% | 0.009 | 0.2535 |
| ADFI | 0.270 | 0.283 | | 0.285 | | 0.008 | 0.3733 |
| ADFIc | 0.270 | 0.283 | 4.8% | 0.285 | 5.6% | 0.008 | 0.3733 |
| G:F | 1.019 | 1.018 | | 1.036 | | 0.016 | 0.6599 |
| GFc | 1.019 | 1.018 | −0.1% | 1.036 | 1.6% | 0.016 | 0.6599 |

d 8-14

| | | | | | | | |
|---|---|---|---|---|---|---|---|
| ADG | 0.401 | 0.398 | | 0.398 | | 0.012 | 0.9816 |
| ADGc | 0.401 | 0.398 | −0.7% | 0.398 | −0.7% | 0.012 | 0.9816 |
| ADFI | 0.462 | 0.473 | | 0.474 | | 0.013 | 0.7338 |
| ADFIc | 0.462 | 0.473 | 2.4% | 0.474 | 2.6% | 0.013 | 0.7338 |
| G:F | 0.870 | 0.843 | | 0.842 | | 0.012 | 0.1635 |
| GFc | 0.870 | 0.843 | | 0.842 | | 0.012 | 0.1635 |

d 0-14

| | | | | | |
|---|---|---|---|---|---|
| ADG | 0.338 | 0.343 | 0.347 | 0.009 | 0.7596 |
| ADGc | 0.338 | 0.343 | 0.347 | 0.009 | 0.7596 |
| ADFI | 0.366 | 0.378 | 0.379 | 0.009 | 0.5286 |
| ADFIc | 0.366 | 0.378 | 0.379 | 0.009 | 0.5286 |
| G:F | 0.925 | 0.909 | 0.915 | 0.007 | 0.2946 |
| GFc | 0.925 | 0.909 | 0.915 | 0.007 | 0.2946 |
| Fecal Score | 1.00 | 1.00 | 1.00 | 0.000 | 0.5235 |

In general, ADG is measured as (average weight out−average weight in)/days between in and out. Average weight is calculated as the total body weight divided by the number of animals weighed. ADFI is measured as average amount of feed consumed per piglet/number of days). The feed consumed is based on the reduction of feed in the feeder based on the starting amount of feed (e.g., feed consumed=starting feed amount−remaining feed amount), divided by the number of piglets.

Fecal score for the piglets in the trial was based on a scale from 1 to 4 (1=firm/normal stool; 2=soft; 3=very soft; 4=watery diarrhea). All observations of fecal score on d4, 7, and 11 were 1 (normal). On d14, few scores of 2 (soft) and 1 score of 3 (very soft) were observed. (data not shown) There were no differences in the probability of having a waterier stool among the various treatments (P>0.05).

There was no piglet mortality throughout the trial, and therefore mortality rate could not be measured. This is an indication of the high quality of the piglets, feed, and other trial conditions.

Even if not significant, the greatest effects on performance were observed during the first week post-weaning (trial days 0-7), which is the most critical period for nursery pigs. In this first week post-weaning there was a numerical improvement in both ADG and ADFI when either insect oil or palm kernel oil was included in the piglet feed (replacing soy oil). The lack of statistically significant effects on the insect oil on growth performance, stool quality, and mortality may be due to the low challenge and low stress conditions of the trial. Under harsher challenge conditions, the benefits of the insect oil in the feed will likely be more apparent.

Overall, compared to the control feed, the replacement of 1.5% of soy oil with either insect or palm kernel oil did not affect overall performance and stool quality. Effects of feeding insect oil were observed only in the first week with numerical improvements of ADG and ADFI. These data also demonstrate that piglets can safely be fed diets with 1.5% insect oil at 0-14 days post weaning without negatively impacting piglet performance.

### Example 4— Insect Oil and Palm Kernel Oil Effect on Nursery Piglets' Performance

To study the effect of insect oil and palm kernel oil on nursery piglets, piglets were fed diets with oil extracted from Hermetia Illucens larvae or with palm kernel oil. Two consecutive batches of about 1520 post weaning (day 21) piglets (total of 3040 piglets in the trial) were assigned to one of the two experimental treatments outlined in Table 18. Piglets were housed with about 40 piglets per pen in about 38 pens, with 760 total piglets per treatment, per batch (1520 total piglets per treatment in the trial). The trial ran over 14 days and was executed in two subsequent batches of piglets to accommodate sufficient experimental units per dietary treatment. Parameters including growth performance (body weight, ADG, ADFI, G:F), removal (number of piglets removed from trial), mortality (number of deaths/culled piglets), and stool quality (fecal score) were tested throughout the trial.

TABLE 18
Piglet feed treatments

| Treatment | Oil source inclusion |
|---|---|
| 1 | Palm kernel oil 1.5% + soy oil 1.5% |
| 2 | Insect oil 1.5% + soy oil 1.5% |

Body weight of the piglets was similar for piglets of both treatments on day 0 of the trial. On day 14 of the trial, BW of piglets fed PKO was 8.13 kg, and 8.00 kg for piglets fed insect oil. This difference was not significant.

In the first phase post weaning (d0-14 post weaning (“pw”)), a significantly lower daily growth (24 g/day less) was observed in the insect oil treatment (P<0.05) compared to the piglets receiving PKO treatment. Average daily feed intake (ADFI) was similar among dietary treatments (P>0.10). Gain to feed tended to be higher from d0-14 pw for the PKO treatment (P=0.08) caused by higher body weight and similar feed intake compared to the insect oil treatment. In the second phase post-weaning (d14-42 pw), piglets no longer received experimental treatments and thus received a similar diet. Piglet performance was measured to determine any potential carry-over effect of experimental treatment from d0-14 pw. From d14-42 pw, compensatory growth was observed of the piglets previously receiving insect oil treatment. These piglets tended to have a higher ADG (P=0.08). In the overall trial (d0-42 pw), no differences were observed among the treatments (P>0.10).

In general, ADG is measured as (average weight out−average weight in)/days between in and out. Average weight is calculated as the total body weight divided by the number of animals weighed. ADFI is measured as average amount of feed consumed per piglet/number of days). The feed consumed is based on the reduction of feed in the feeder based on the starting amount of feed (e.g., feed consumed=starting feed amount−remaining feed amount), divided by the number of piglets.

Fecal score for the piglets in the trial was based on a scale from 1 to 4 (1=Diarrhea, water thin manure >50% of the piglets soiled; 2=Soft manure and >10% of the pigs soiled; 3=Normal stools, max 10% of the piglets soiled; 4=Shaped stools, 100% clean piglets). Stool quality was daily scored from d2-13 pw. Stool quality was acceptable in both treatments (all scores were 3 or 4) and no clear dietary effect was observed. Diarrhea was not observed in any of the pens.

Throughout the trial (from d0-42 pw), piglets were counted that were removed from the trial and that died during the trial. On day 14 post weaning, more piglets had been removed from trial from the insect oil treatment. Removals were caused mainly by Streptococcus suis related symptoms. Streptococcus suis is a bacterium causing infections and is a common health problem for piglets. This resulted in a significantly higher % of pigs removed compared to the PKO treatment (P<0.05). On day 42 pw, however, no difference in piglet mortality or removals in the overall trial could be observed among treatments (P>0.10). This is showing that in this phase more piglet mortality and removals occurred for the treatment receiving PKO.

To summarize the results in this trial, piglet growth was significantly reduced in the first 14 days of the trial when insect oil was provided instead of PKO. These piglets, however, showed a higher growth in the later phase (d14-42), leading to a similar ADG for both treatments considering the complete trial period. Dietary treatment did not impact feed intake, hence leading to a tendency of lower G:F in the period of d0-14 pw. The health challenge that occurred in the farm seemed to have a stronger impact on the piglets that received the insect oil treatment from d0 to 14. This was observed through a higher number of piglets removed from trial. This effect, however, was reversed in the period between d14 and 42, leading to similar mortality and morbidity values for the overall trial. This means that using insect oil to replace PKO will not impact overall piglet performance.

### Example 5— Insect Oil Effect on Suckling Piglet Performance

To study the effect of insect oil and palm kernel oil on suckling piglets (piglet that are still with the sow), piglets were fed diets with fat extracted from Hermetia Illucens larvae. The effect of insect oil was compared to that of palm kernel oil (PKO). For this trial, 12 litters inclusive of both the sow and piglets were blocked by parity (i.e. the age of the sow). Before start of the trial, all piglets were weighed and switched across the different sows in order to have equal litters (similar body weight range) between pairs and within the blocks. Sows were fed standard diets. Piglets were offered creep feed and were allocated to a creep feed with either insect or palm kernel oil. The experimental diets are outlined in Table 19. All sow and litters were paired with an adjacent sow and litter. From the start of the trial, on a daily basis the litters of these two adjacent sow were swapped, together with their experimental diet and feeding bowl. This approach was chosen to reduce the variation in piglet performance caused by difference in milk production across sows. This trial lasted 17 days, and data on growth performance of the piglets was measured on day 17. Piglets were weaned at approximately 21 days of age, which corresponded to day 17 of the trial. Growth performance parameters include body weight (BW), BW gain, and feed intake (FI).

TABLE 19
Piglet feed treatments

| Treatment | Oil source inclusion |
|---|---|
| 1 | Palm kernel oil 1.5% + soy oil 1.5% |
| 2 | Insect oil 1.5% + soy oil 1.5% |

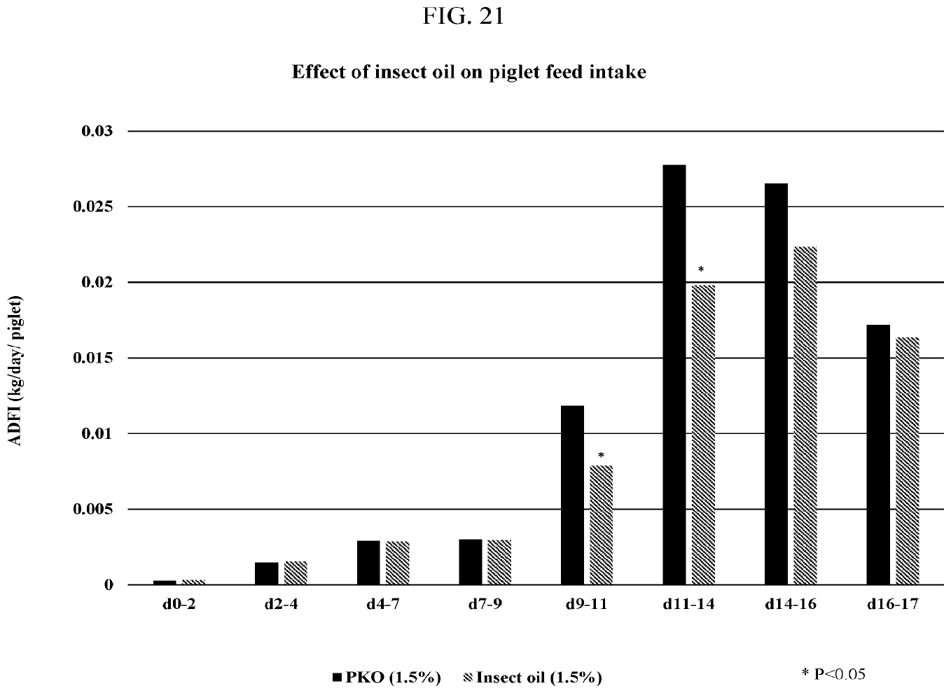

The inclusion of insect oil significantly reduced feed intake in the overall trial period (d0-17). FI was not affected from d0-2, 2-4, 4-7, 7-9, d14-16 and d16-17 (P>0.05). FI was significantly reduced from d9-11 and 11-14 (P<0.05). The results of feed intake are shown in FIG. 21. Piglet weaning weight (d17 of the trial) was not affected by treatment, nor was BW gain. Mortality was measured throughout the trial and was not affected by treatment.

Overall, compared to the control feed with PKO oil, the treatment with 1.5% insect oil significantly reduced piglet feed intake from d9-14 of the trial. This led to significant reduction in feed intake for the insect oil treatment in the overall trial. After the adaption period to the feed (between d9-14), the difference in feed intake is slowly disappearing. It is hypothesized that for piglets that are weaned at a later age (>21d of age), the negative feed intake impact will be lower or negligible.

### Example 6— Insect Oil Effect on Suckling Piglet Performance

To study the effect of insect oil and palm kernel oil on suckling piglets (piglet that are still with the sow), piglets were fed diets with fat extracted from Hermetia Illucens larvae. The effect of insect oil was compared to that of palm kernel oil. Because of the negative feed intake effect observed in Example 5, it was decided to run another trial with slightly lower inclusion level (0.5 instead of 1.5%). For this trial, 12 litters inclusive of both the sow and piglets were blocked by parity (i.e. the age of the sow). Before start of the trial, all piglets were weighed and switched across the different sows in order to have equal litters (similar body weight range) between pairs and within the blocks. Sows were fed standard diets. Piglets were offered creep feed and were allocated to a creep feed with either insect or palm kernel oil. The experimental diets are outlined in Table 20. All sow and litters were paired with an adjacent sow and litter. From the start of the trial, on a daily basis the litters of these two adjacent sows were swapped, together with their experimental diet and feeding bowl. This approach was chosen to reduce the variation in piglet performance caused by differences in milk production across sows. This trial lasted 20 days, and data on growth performance of the piglets was measured on day 20. Piglets were weaned at approximately 21 days old, which corresponded to day 20 of the trial. Growth performance parameters include body weight (BW), BW gain, and feed intake (FI).

TABLE 20
Piglet feed treatments

| Treatment | Oil source inclusion |
|---|---|
| 1 | Palm kernel oil 0.5% + soy oil 2.5% |
| 2 | Insect oil 0.5% + soy oil 2.5% |

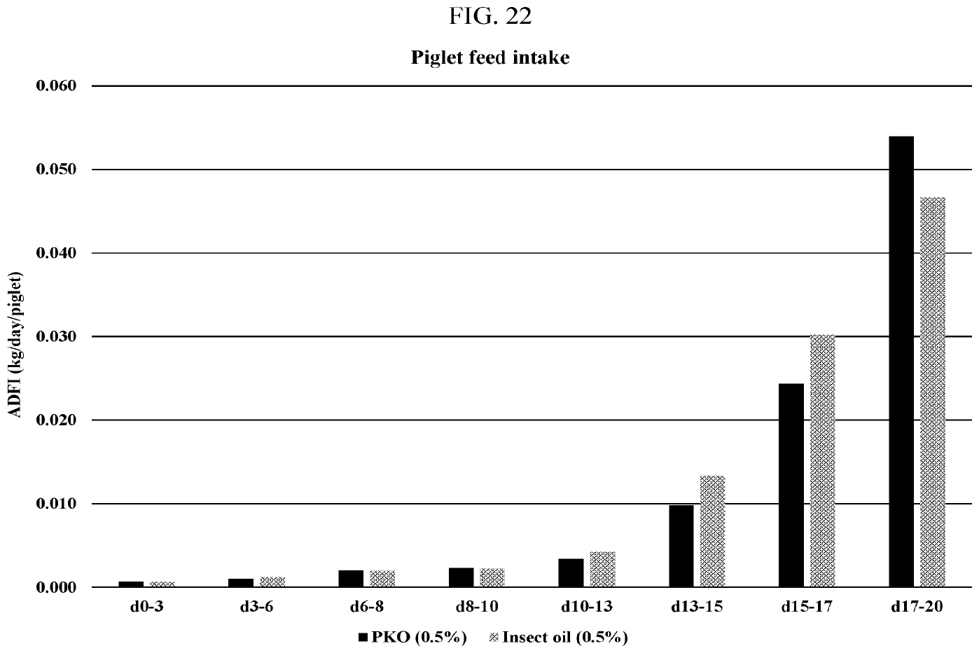

The inclusion of insect oil did not affect feed intake in the overall trial period (d0-20), nor in the separate measurement periods (d0-3, 3-6, 6-8, 8-10, 10-13, 13-15, 15-17, 17-20) (P>0.05). The results of feed intake are shown in FIG. 22. Piglet weaning weight (d20 of the trial) was not affected by treatment, nor was BW gain. Mortality was measured throughout the trial and was not affected by treatment.

Overall, compared to the control feed with PKO oil, the treatment with 0.5% insect oil did not affect piglet performance in this trial. These data demonstrate that pre-weaning piglets can safely be fed diets with 0.5% insect oil without negatively impacting piglet performance.

1. A method for increasing the weaning weight of piglets, the method comprising feeding a piglet milk from a sow fed a swine feed comprising about 0.1 wt % to about 10.0 wt % insect oil, whereby the piglets have a higher average weaning weight than piglets fed milk from a sow fed a feed without insect oil.

2. The method of claim 1, additionally comprising the step of feeding the sow the swine feed comprising about 0.1 wt % to about 10.0 wt % insect oil.

3. The method of claim 1, wherein weaning weight of the piglets is based on weaning the piglet between day 15 and day 30 post birth.

4. The method of claim 1, wherein the piglets are additionally fed a feed comprising about 0.25% to about 5% insect oil.

5. The method of claim 1, wherein the weaning weight of the piglets is at least 4% higher than the weaning weight of piglets in a corresponding method using swine feed without the insect oil.

6. The method of claim 1, wherein the weaning weight of the piglets is at least 12% higher than the weaning weight of piglets in a corresponding method using swine feed without the insect oil.

7. A method for increasing feed efficiency in a piglet comprising feeding the piglet a swine feed comprising between about 0.1 wt % and about 10.0 wt % insect oil, whereby the feeding efficiency of the piglet is increase relative to the feeding efficiency of a piglet fed a feed without insect oil.

8. The method of claim 7, wherein the piglet is between 0 and 60 days old.

9. The method of claim 7, wherein the piglet is less than 21 days old.

10-11. (canceled)

12. The method of claim 7, wherein the feed efficiency of the piglets is at least 2% higher than the feed efficiency of piglets in a corresponding method using swine feed without the insect oil.

13. The method of claim 7, wherein the feed efficiency of the piglets is at least 10% higher than the feed efficiency of piglets in a corresponding method using swine feed without the insect oil.

14-16. (canceled)

17. The method of claim 7, wherein the insect oil comprises about 35% to about 60% lauric acid.

18. (canceled)

19. The method of claim 7, wherein the insect oil is extracted from Hermetia illucens larvae.

20-21. (canceled)

22. A composition that is a swine feed or a feed product for forming the swine feed, the composition comprising insect oil, wherein the insect oil is 0.1 wt % to 10.0 wt % of the swine feed.

23-24. (canceled)

25. The composition of claim 22, wherein the swine feed comprises insect oil and at least one of corn oil, animal fat, vegetable oil, animal-vegetable oil blend, coconut oil, soybean oil, sunflower oil, shea oil, palm oil and combinations thereof.

26. The composition of claim 22, wherein the insect oil comprises about 35% to about 60% lauric acid.

27. (canceled)

28. The composition of claim 22, wherein the insect oil is extracted from Hermetia illucens larvae.

29-30. (canceled)

31. The composition of claim 22, wherein the swine feed is formulated for use in at least one of a breeding, gestation, farrowing, or lactation phase of a sow.

32. The composition of claim 22, wherein the swine feed is formulated as a feed for a piglet less than or equal to 60 days old.

33-34. (canceled)

35. The composition of claim 22, wherein the feed product is formulated to form the swine feed by combining with a base swine feed such that the feed product is 30 wt % or less of the swine feed.

36-43. (canceled)
